(19) United States
(12) Patent Application Publication
(10) Pub. No.: US 2020/0005587 A1
(43) Pub. Date: Jan. 2, 2020

(54) GAME INCLUDING A PHYSICS-BASED GAME FOR DETERMINING A BONUS GAME

(71) Applicant: ADP GAUSELMANN GMBH, Espelkamp (DE)

(72) Inventors: Josef Alexander Hartl, Las Vegas, NV (US); Joshua Matthew Lynn, Las Vegas, NV (US)

(21) Appl. No.: 16/020,574

(22) Filed: Jun. 27, 2018

(51) Int. Cl. G07F 17/32

(52) U.S. Cl. CPC G07F 17/3213; G07F 17/3216; G07F 17/3286; G07F 17/3267

(57) ABSTRACT

Various embodiments of a gaming system and method are disclosed as having a physics-based game for selecting a bonus game type. When a bonus game triggering event occurs in a base game, a physics-based game is executed by the gaming system. In one embodiment, the player provides an input that may allow a player to influence the behavior of a player game object in the physics-based game. Bonus game types are randomly associated with one or more physic-based game target areas. When the player game object is co-located with a game target area, the bonus game type associated with the game target area is determined. The gaming system may then select and execute a bonus game associated with the determined bonus game type.

### FIELD OF THE INVENTION

The present disclosure relates to gaming devices.

### BACKGROUND OF THE INVENTION

Gaming machines that accept wagers in exchange for the opportunity to win awards or prizes are known. Gaming machines that offer new ways to win awards or prizes are needed to gain and retain players' interest in the gaming machines.

### SUMMARY OF THE INVENTION

Various embodiments of a gaming system and method are disclosed as having a physics-based game to determine a second game. In one embodiment, the gaming system and method use a physics-based game to determine one of a plurality of other games. In one such embodiment, the gaming system and method uses a physics-based game to determine one of a plurality of game types, and the gaming system selects one of a plurality of games based on the determined game type.

In some embodiments, the gaming system with the physics-based game utilizes physics-based modeling and player inputs to determine a movement of a player game object in a physics-based game environment of the physics-based game. In some embodiments, the physics-based game environment of the physics-based game includes at least one game target area. In some embodiments, one game type of a plurality of game types is randomly associated with the at least one game target area. In one such embodiment, if the player game object reaches (or hits) the at least one game target area, the gaming system selects a game based on the game type associated with the at least one game target area.

In some embodiments, the physics-based game environment of the physics-based game includes a plurality of game target areas. In some embodiments, a game type of a plurality of game types is randomly associated with each of the plurality of game target areas. In one embodiment, if the player game object reaches (or hits) one of the plurality of game target areas, the gaming system selects a game based on the game type associated with the reached game target area.

In one embodiment of the gaming system and method, the physics-based game is used to select a bonus game from a plurality of bonus games rather than using a random number generator to select a bonus game from the plurality of bonus games. In one embodiment, the gaming system may include a plurality of symbol display areas. The gaming system randomly generates and displays at least one symbol from one or more sets of symbols in each of the plurality of symbol display areas. Each symbol from the sets of symbols may be associated with an award or value. The gaming system evaluates the generated symbols in the plurality of symbol display areas to determine any accumulated award. In one embodiment, one or more symbols from the sets of symbols may be additionally or alternatively associated with a bonus game triggering event. Upon a bonus game triggering event, the gaming system enables a player to play a physics-based game to determine a bonus game. In one embodiment, play of the physics-base game may determine a bonus game type, and the gaming system selects and presents to the player a bonus game based on the determined bonus game type. In some embodiments, the player interacts with the gaming system to exert at least some influence over a player game object in the physics-based game.

In one embodiment of a gaming system and method including the physics-based game, the gaming system may include a plurality of symbol display areas associated with a plurality of video-based slot machine reels. For example, the gaming system may include five video-based slot machine reels that are each associated with three symbol display areas. The gaming system further includes a symbol set that includes a plurality of symbols for each of the five video-based slot machine reels. The gaming system generates a plurality of symbols from each of the symbol sets for the plurality of symbol display areas on each of the five video-based slot machine reels. The gaming system evaluates the generated plurality of symbols for winning symbol combinations. The gaming system also evaluates the generated plurality of symbols for triggering symbols. If the gaming system determines that at least one triggering symbol was generated, the gaming system may enable the player to play a physics-based game to determine a bonus game.

In some embodiments of the physics-based game, the gaming system generates and displays a physics-based game environment, or playfield, to the player. The physics-based game environment includes a player game object that traverses the physics-based game environment and may interact with one or more other game elements or game obstacles. The game environment may additionally include one or more game target areas. The gaming system enables the player to attempt to direct the player game object towards the one or more game target areas of the game environment. One or more bonus game types may be associated with the one or more game target areas. In some embodiments, each of the plurality of game target areas may be associated with one of the plurality of bonus game types. In some embodiments, the association of bonus game types with game target areas may be random. In one embodiment, when a player game object is co-located within a game target area, the gaming system determines the bonus game type associated with the game target area. The gaming system selects a bonus game corresponding to the determined bonus game type. The gaming system enables the player to play the selected bonus game.

In some embodiments, the player, using inputs to the gaming system, may initially influence or direct a movement of a player game object in the gaming system. In some embodiments, the player may influence or direct the trajectory of the player game object towards the one or more game target areas. In alternative embodiments, the player may influence or direct a stationary, but rotational movement (e.g., a movement of a wheel that rotates about a fixed point) of a player game object. In some embodiments, more than one player game object may be utilized during play of the physics-based game. In some embodiments, the physics-based game environment of the gaming system may additionally include one or more game elements. As the player game object traverses the physics-based game environment, the player game object may interact with one or more game elements which may alter the trajectory of the player game object. As the player game object traverses the physics-based game environment and interacts with one or more game elements, the gaming system may periodically re-calculate the player game object trajectory utilizing a physics-based modeling engine. The physics-based modeling engine may use any number of suitable factors in its calculations, such as, but not limited to: speed, direction, gravity, wind velocity and direction, friction, impact angle, rigid body dynamics, soft body dynamics, spring force, material energy absorption, and the like. It should be appreciated that any suitable physics-based modeling engine may be utilized. It should be appreciated that, in some embodiments, the modeling engine may supplement or replace random or pseudo-random generation of game outcomes.

In one embodiment, the physics-based game for determining a bonus game type may be a surface projectile game having a substantially vertical play surface (e.g., a pachinko-type game). In one embodiment, the physics-based game for determining a bonus game type may be a surface projectile game having a substantially horizontal play surface (e.g., a pinball-type game, a billiard-type game, a bowling-type game). In another embodiment, the physics-based game for determining a bonus game type may be an aerial projectile game (e.g., a baseball-type game, a golf-type game, a projectile toss-type game). In another embodiment, the physics-based game for determining a bonus game type may be a race-to-the-finish game (e.g. a vehicle racing game; a task completion race game, an obstacle course game). In yet another embodiment, the physics-based game for determining a bonus game may be a strategy projectile game (e.g., a barrier elimination-type game), or any other suitable type game. In yet another embodiment, the physics-based game for determining a bonus game may involve a spinning pointer type game, a spinning wheel type game, or a spinning top type game.

It should therefore be appreciated that a gaming system and method physics-based game for determining a bonus game creates new and very exciting ways for a player to influence the selection of a bonus game when a bonus game is awarded during base game play. By enabling a player to influence a player game object displayed in a gaming system during the play of a physics-based game, the player has the potential to earn greater awards a resultant bonus game. Moreover, by enabling a player to influence a player game object displayed in a gaming system during the play of a physics-based game, the gaming system may rely on alternatives to random number generation to determine certain outcomes in a play of a game.

### BRIEF DESCRIPTION OF THE DRAWINGS

FIG. 1 is a perspective view of one embodiment of a stand-alone gaming device of a gaming system.

FIG. 2 is a functional block diagram of the gaming device technology components of the gaming system.

FIGS. 3A, 3B, 3C, and 3D illustrate one embodiment of a method of operating the gaming system including a physics-based bonus game selection game.

FIGS. 4A, 4B, 4C, 4D, illustrate screen shots of one embodiment of a gaming system comprising a physics-based bonus game selection game.

FIG. 4E illustrates one embodiment of a method of calculating a player game object trajectory in a physics-based game.

FIG. 4F illustrates one embodiment of a method of associating bonus game types with physics-based game target areas.

FIGS. 5A and 5B illustrate embodiments of bonus games corresponding to different bonus game types.

FIGS. 6A and 6B illustrate some embodiments of physics-based bonus game selection games.

### DETAILED DESCRIPTION OF THE INVENTION

Various embodiments of a gaming system and method are disclosed as including a physics-based game for determining a bonus game. In some embodiments, the gaming system receives at least one player input into the physics-based game. The gaming system enables a player's input to the gaming system to influence an aspect of the player game object and certain outcomes in a play of a game. The gaming system with a physics-based game may determine a player game object movement, based in part on the player input. The player game object trajectory may traverse a physics-based game environment towards one or more game target areas. In some embodiments, the physics-based game includes at least one game target area having a bonus game type associated with the game target area. The bonus game type may be randomly associated with the game target area. In some embodiments, the gaming system periodically changes the association between bonus game types and the game target areas while the player game object traverses the physics-based game environment. In one such embodiment, when the player game object hits (reaches or is co-located with) a game target area, the gaming system stops the periodic changing of the associations between the bonus game types and the game target areas. In some embodiments, the gaming system uses the bonus game type that is displayed in the hit game target area to determine a bonus game. The gaming system may select and display a bonus game from a plurality of bonus games associated with the determined bonus game type to a player. It should be appreciated that a bonus game, rather than a bonus game type, may be associated with a game target area in some embodiments.

In one embodiment including a physics-based game for determining a bonus game, a virtual or simulated pachinko-type game may be initiated upon the occurrence of a triggering event during play of a base game. In some embodiments of the physics-based game, the gaming system creates and displays the simulated pachinko-type game playfield to the player. The pachinko-type game playfield includes a game ball that traverses the game playfield. The game playfield may additionally include one or more game target areas. A player activated plunger on the gaming system may direct the game ball towards the one or more game target areas. In one embodiment, the resulting speed at which the game ball enters the game playfield may be influenced by the player via the plunger. Once projected onto the game playfield, the game ball trajectory over the game playfield may be determined by a physics-based modeling engine. The game ball may ultimately come to rest in (or reach, hit, become co-located with) a game target area. One of a plurality of bonus game types may be associated with each of the one or more game target areas. In some embodiments, the gaming system periodically and randomly changes associations between the plurality of bonus game types and the plurality of game target areas. In some embodiments, the gaming system periodically changes the associations between the plurality of bonus game types and the plurality of game target areas in a way that is not random (e.g., systematically rotating the bonus game type associations between the plurality of game target areas). In one embodiment, the bonus game type associated with the game target area is determined when a game ball is co-located with a game target area. The gaming system may select and present a bonus game corresponding to the determined bonus game type to the player. In some embodiments the selection is random while in other embodiments the selection is predetermined based on the determined bonus game type.

### Gaming Device Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

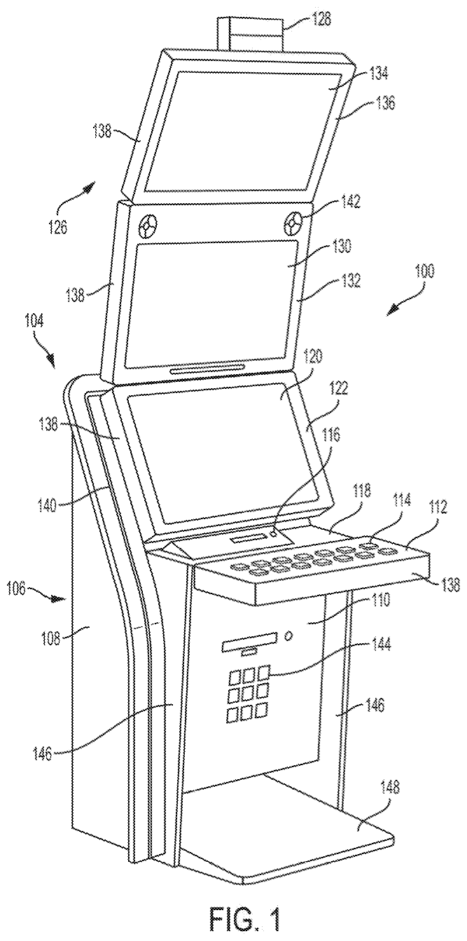

One embodiment of a gaming device platform is shown in FIG. 1 where a gaming device 100 is generally shown. In one embodiment, the gaming device 100 is referred to as a slot machine and is illustrated as housed in a housing or cabinet constructed so that a player can operate and play the gaming device 100 while standing or sitting.

Gaming device 100 may include cabinet 104 for housing the components fully described hereinbelow. The cabinet 104 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming device, as can be seen in FIG. 1.

It should be appreciated that a wide variety of cabinet enclosure sizes, shapes, and designs are possible for the gaming device 100. Cabinet 104 may function to securely protect any local control system, technology components, and provide support for game display(s) and player input and output interactions with the gaming device.

Returning to FIG. 1, the gaming device enables the player to interact with the gaming device 100 to direct the wagering and game play activities and preferences. Various forms of player interaction devices and activities will now be described.

Cabinet 104 includes a player interaction area having input and output areas generally designated as 112. The player interaction area 112 may be located on the front top side of cabinet 104 and, as shown, on a panel structure that extends outwardly from the gaming device in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming device 100 and direct game play. It is expected that cabinet 104 provides an easily accessible location and support for all necessary player input/output (I/O) interactions with the device, including gaming control interactions and value wagering interactions. Although the gaming device 100 illustrated in FIG. 1 shows player controls provided by buttons of player control button area 114, it is understood that in one embodiment, a player's gaming control interactions could be made by either buttons mounted on cabinet 104 or “soft” buttons located on the gaming display and activated by player touch (e.g., touch screen interfaces), or a combination of both arrangements.

Player control button area 114 may include, for example: game selection button(s) in any embodiments where more than one game is provided in a single gaming device; gaming denomination value selection button(s) in any embodiments where one or more wagering denomination value is accommodated; wager selection button(s) for the player to indicate or select the desired wager value for a game in any embodiments where a selection of wager values are offered; pay line selection button(s) for selecting the number of active pay lines in game embodiments that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information. As discussed above, the functions of the buttons in player control button area 114 may be duplicated with soft buttons in the player control button area 114 or as soft buttons in other areas of the gaming device 100 (e.g., as a touch screen overlay over available game displays).

Gaming device 100 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming device 100 via one or more value acceptor devices. In one embodiment, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming device 100 accepts coins and bill, the gaming device 100 includes a currency bill validator and a coin validator as the value acceptor devices. Likewise, if the gaming device 100 accepts tickets, the gaming device includes a ticket acceptor as a value acceptor device for receiving tickets or vouchers representing some monetary value. The ticket acceptor may include a bar code reader, or other appropriate code reader, for reading the encoded value contained by the player's ticket or voucher. In some embodiments, the player value acceptor and dispenser area 116 may include a value acceptor device that can accept more than one type of value. In some embodiments, the player value acceptor and dispenser area 116 may include multiple different value acceptor devices to accept different types of value from players

Upon receipt of some type of value from the player, a value acceptor device of the player value acceptor and dispenser area 116 performs validation on the player supplied value using appropriate hardware readers (e.g., determining that the currency bills/coins/tokens are genuine, or the ticket/voucher is genuine). If the validation result is positive on player supplied value, the appropriate value acceptor device generates a signal to a processor of the gaming device 100 to establish a gaming credit balance for plays of one or more games on gaming device 100.

In one embodiment, a player receives monetary value, or a representation thereof, from the gaming device 100 when a player chooses to “cash out” the gaming credit balance (e.g., remove value from the gaming device 100). The player can cash out at any suitable time. When a player cashes out the value contained on a credit meter (not shown) of gaming device 100, a processor of gaming device 100 may cause a printer of gaming device 100 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device or converted to currency at a conveniently located kiosk or cashier counter located near the gaming device. Alternatively, the processor of gaming device 100 may cause a currency bill dispenser or a coin dispenser in gaming device 100 to dispense the value contained on the credit meter of gaming device 100.

Various combinations of the above value acceptance and value distribution arrangements are possible. Gaming device 100 may include other value acceptance and value distribution mechanisms in the player value acceptor and dispenser area 116. For example, gaming device 100 may include a magnetic strip or chip card reader/writer in order to accept value from and transfer value to a magnetic strip or an embedded chip card. In other embodiments, hardware for transferring (and receiving) non-traditional currencies to players such as digital currencies (e.g., bitcoin) may be included in gaming device 100.

In an alternative embodiment, gaming device 100 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming device may be associated with the player account. It is noted that a numeric or alphanumeric keypad may be provided adjacent to the card reader slot to enable player entry of a personal identification number or the like for secure access to card information.

In one embodiment, a player convenience input area 118 may be included in the gaming device 100, as is shown in FIG. 1. In various embodiments, player convenience input area 118 may have a variety of features and functions depending on the jurisdictional deployment of the gaming device 100. In one embodiment, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming device during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain embodiments, the player convenience input area 118 may include player convenience features such as a pocket for storage that allows players to store their personal items such as a mobile phone. Gaming device 100 may include one or more universal serial bus (USB) ports that enables a player to charge their electronics or connect to services such as the Internet or food service. Further, player convenience input area 118 of gaming device 100 may include buttons to request food or drink service if the gaming device is located in an establishment that has food and drink service. The gaming device 100 may be connected to a local or wide area network such that selection of the requested food or drink service will alert the establishment's hospitality staff to deliver the requested service directly to the gaming device 100.

The layout of the player control button area 114, player value acceptor and dispenser area 116 and the player convenience input area 118 in gaming device 100 may be arranged differently than those disclosed and illustrated herein. The selections and arrangement of input locations on the cabinet 104 may be dependent upon the game buttons, the type of value wagered, and the player conveniences utilized in the deployment configuration of gaming device 100.

With continuing reference to FIG. 1, in one embodiment, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated embodiment, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one embodiment, gaming device 100 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming device conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one embodiment, as illustrated in FIG. 1, gaming device 100 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one embodiment. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some embodiments, the angles between the displays may be adjustable and may be smaller or greater than the angles illustrated in FIG. 1. Further, it is understood that in some embodiments the displays may be disposed in a common plane relative to each other.

It also should be appreciated that in various embodiments a variety of display technology may be utilized equivalently and interchangeably with a variety of embodiments of the gaming device. Equivalent display devices include all variations of liquid crystal displays, light emitting diode displays, and plasma displays.

In some embodiments, different sized displays may be combined to display gaming data on gaming device 100. As a non-limiting example, a 27-inch widescreen LCD display may be combined with a 20-inch portrait oriented LCD or a light emitting diode (LED) display. This combination may be used, for example, with a third scrolling banner LED display. In alternative embodiments, one, two, three, or more displays could be used in a variety of positions and orientations. Any suitable combination may be used. It should also be appreciated that a processor of gaming device 100 may communicate with the disclosed first game display 120, second game display 130, and third game display 134 through a video card of gaming device 100 to produce the visible aspects of a game.

In one embodiment, one or more of the first game display 120, second game display 130, and third game display 134 may be fitted with a transparent touch sensitive overlay for sensing player touch inputs into the gaming device. Touch sensitive overlays can communicate with a processor of gaming device 100 to enable the player to interact with the game.

In some embodiments, the curved displays may be used for any or all of the first game display 120, second game display 130, or third game display 134. Similarly, any of the displays used for gaming device 100 can be based on flexible display technologies. For example, it is possible to utilize flexible display technologies to create uniquely shaped curving, wavy, or tubular display structures to provide one or more of the first game display 120, second game display 130, and third game display 134. Additionally, in one embodiment flexible display technologies can be used in combination with fixed flat screen technologies.

While the gaming device 100 has been described as implemented with video technologies, in one embodiment, mechanical reels with reel strips containing game indicia and step motor controllers may be employed to provide game information to a player. In one embodiment, the reel strips may include a plurality of printed symbols. In another embodiment, the mechanical reels may include flexible video display technology as the reel strips on mechanical reels. Thus, games implemented in video form can readily be implemented with mechanical reels utilizing such display technology. Alternatively, in other embodiments mechanical reels with reels strips having fixed symbols displayed along the reel strip could be used to implement the game.

Dependent upon the particular gaming device housing style, a variety of other display technologies may be utilized in combination with the gaming device disclosed herein. For example, in some embodiments a gaming device may have one or more display devices in addition to the main game display(s). For example, the gaming device may include a player tracking device having a player tracking display which displays various information to the player regarding the player's status. The gaming device may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming device 100. In the embodiment of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming device 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one embodiment, the circuit boards are flexible circuit boards. These LED strips and transparent or translucent coverings may surround one or more gaming device displays frames, as well as the player interaction area, to highlight these areas.

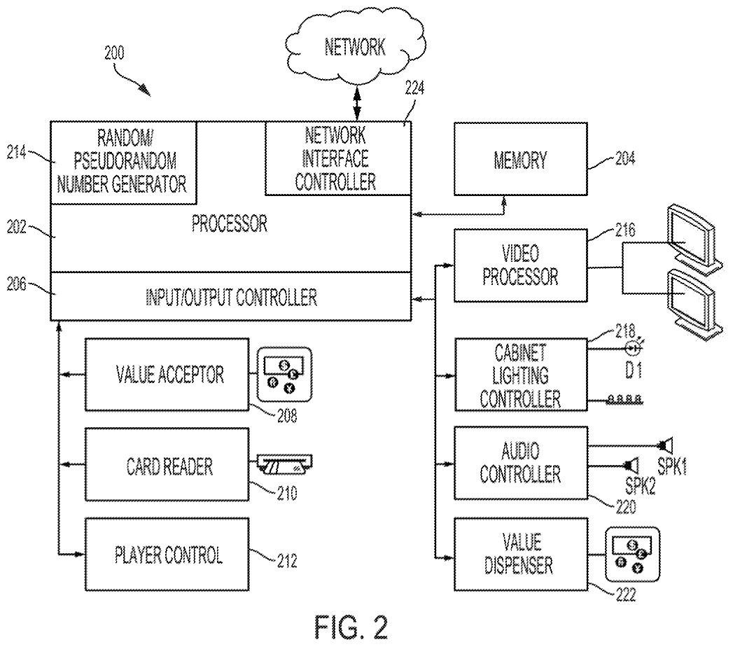

In one embodiment, the individual LEDs mounted on the LED strips are of a type that can emit red, green, and blue light. In an alternative embodiment, separate LEDs are used for each required light color. All LED strips can be electrically connected and can be controlled by a cabinet lighting controller 218 (illustrated in FIG. 2) in conjunction with a processor of gaming device 100 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some embodiments, cabinet 104 may include LED strip lighting or LED rope lighting to accentuate the cabinet and enhance the attractiveness of gaming device 100 to players. LED rope lighting is a plurality of small light-emitting diode bulbs linked together and encased in a plastic, polyvinylchloride, or other suitable material to create a string of lights. For example, in the embodiment of FIG. 1, cabinet 104 includes cabinet accent lighting 140. In one embodiment, cabinet accent lighting 140 is LED rope lighting mounted flush with the front side edge of the cabinet side panels 108. The LED rope lighting can generate any of suitable colors, and are controlled by cabinet lighting controller 218 and a processor of gaming device 100 to selectively mix the emitted light colors in a manner to create any color in the same manner as the frame edge lighting.

In various embodiments, gaming device 100 includes one or more audio speakers and appropriate driving electronics and sound cards so that game players may experience pleasing audio aspects of the gaming device 100. Audio is desirable to attract and maintain player interest in gaming device 100. Gaming device 100 may also emit attraction sounds during any idle period of gaming device 100. Game audio may add to the player's enjoyment of gaming device 100 by providing music and sound effects designed to enhance and compliment the gaming experience.

Audio speaker hardware may include one or more speakers disposed in or on the cabinet 104 of gaming device 100. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some embodiments. Speaker placement may be selected to enhance the sound emitting characteristics of the gaming device. For example, bass speakers or additional speakers 144 may be mounted inside lower cabinet body portion 106. Further, it is envisioned that in some embodiments sound processing such as multichannel processing and surround sound processing are included in gaming device 100. Audio jacks for attachment of player headphones may also be provided in some embodiments of gaming device 100 for the player to further enhance the audio experience of the game and also to block out noise from other gaming devices.

In one embodiment, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming device 100 in a seated position. Foot rest 148, which may be cushioned, is provided below player interaction area 112 to enhance a player's ergonomic comfort while playing gaming device 100. In one embodiment, the edges of player interaction area 112 may be ergonomically cushioned as well.

Gaming device 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some embodiments the gaming device 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one embodiment, housing styles of cabinet 104 of gaming device 100 may include bar top or table top housing arrangements. These housings are generally small enough to be placed on top of an existing bar or table while providing the requisite gaming device housing functions of protection of/access to gaming electronics, displays, and player I/O functions described above.

In one embodiment, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming device 100.

FIG. 2 illustrates a functional block diagram of an embodiment of technology components of gaming device 100 that are specially configured to carry out the game function and operations described herein. The functional elements shown in FIG. 2 cooperate, on a broad and general level, to function as gaming device 100. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In one embodiment, gaming device 100 is functionally controlled by control unit 200. Control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one embodiment, control unit is also configured to communicate with a server device through a network.

In one embodiment, control unit 200 includes at least one specially configured processor 202 or central processing unit (CPU). In one embodiment, specially configured processor 202 include arithmetic logic units and math co-processors also known as floating point units. In one embodiment, specially configured processor 202 includes registers for holding instructions or other data, and cache memory for storing data for faster operation thereupon. In one embodiment, specially configured processor 202 may be a multi-core processor that includes two or more processors for enhanced performance, more efficient parallel processing, or other advantageous computing functions. In another embodiment, specially configured processor 202 may be one or more processing devices such as microprocessor(s) or integrated circuit(s) and may include one or more controllers. It should be appreciated that in some embodiments, a general purpose processor could be programmed to perform the functions of specially configured processor 202.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

At least one specially configured processor 202 or controller of control unit 200 is specially configured to communicate with at least one memory device, generally shown as memory device 204 in FIG. 2. In one embodiment, memory device 204 includes one or more memory structures for storing instructions and various types of game data. Memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor or a controller encompasses the processor or controller accessing the memory device, exchanging data with the memory device, or storing data to the memory device.

Memory device 204 may store all program code and game code (collectively the “code”), and operation data necessary for the operation of the gaming device 100 and execution of the gaming features described hereinbelow. In an alternative embodiment, game code and operation data necessary for the operation of the gaming device 100 may be store in a distributed manner such that some code is stored in memory device 204 and other code is stored remotely from gaming device 100. In one embodiment, the code and operation data necessary for the operation of the gaming device includes, for example, basic input and output function data, instruction fetching data, bus and network communication protocol data, and like data necessary for an operational gaming device 100. In one embodiment, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in one embodiment, the code and operation data for the operation of the gaming device described above may be stored in removable game cartridges or flash drives, a compact disk ROM, a digital versatile disk (DVD) optical storage technology, or suitable other fixed non-transitory storage mediums. In another embodiment, part or all of the code and operational data for operation of the gaming device or for execution of the game features may be stored in a remote memory structure and be downloaded to the memory device 204 via a network connection.

In one embodiment, the gaming device 100 may utilize any combination of memory devices such as random access memory devices (RAMs), unalterable memory devices (ROMs), and mass storage devices for securely storing and securely communicating the software components or code that facilitate game play and other functions of the gaming device 100. The memory devices may store software components or code that include various game data and game related control and execution software. In some embodiments, the software components stored in the memory devices may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the gaming device 100.

In some embodiments, the memory devices, such as memory device 204, with the software components and other data may be secured and authenticated by authentication software stored in an unalterable memory device within the housing of gaming device 100. The gaming device 100 may also include application specific integrated circuits (ASICs) to perform the security and authentication functions. At any appropriate time, such as before each play of a game, at a predetermined interval, upon transfer of any game data or any software components from a mass storage to memory device 204, or upon demand, the gaming device 100 (using a processor such as processor 202 or a separate ASIC) may execute an authentication routine and perform an authentication of any software component or other data of the gaming device 100. In one embodiment, the gaming device software components may be prepared for authentication via creation and storage of an encrypted signature unique to one or more of the software components.

In one embodiment, an encrypted signature may be created by utilizing a hash function on a software component or code to form a message digest (i.e., a hash of the software component) followed by a key encryption of the message digest to form an encrypted signature unique to the software component. In some embodiments, the key encryption may be public key encryption, private key encryption, or any suitable key encryption schema. The encrypted signature may be stored with the gaming device software component, for example, in a mass storage device or an unalterable memory. During a software component authentication, the gaming device 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and gaming device 100 may allow game play to proceed. However, when the message digests do not match, the gaming device 100 may determine that the software component under authentication may be corrupted or fraudulent and game play may be halted. It should be appreciated that the gaming device 100 may perform other suitable security and authentication checks on the game data or software components. Such authentication and security devices and functions are unique to gaming and casino industry to minimize or prevent fraud in gaming devices and gaming systems.

For a player to interact with gaming device 100, control unit 200 receives and processes player inputs, and control unit 200 causes processed results to be output or communicated to the player. In one embodiment, player inputs are recognized and processed or directed for processing by input/output (I/O) controller 206. Further, I/O controller 206 may process and direct player outputs for communication to the player. I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for each attached input device and output device. In this manner, specially configured processor 202 is freed from the operational details of the peripheral I/O devices. For example, in one embodiment where an input or output device is changed or upgraded, I/O controller 206 can be changed without changing other gaming system 100 components.

In one embodiment, a player deposits value into gaming device 100 by inserting some form of currency into a value acceptor 208 for game play. Alternatively, a player deposits value into gaming device 100 by inserting an encoded paper ticket into a value acceptor 208 for game play in one embodiment. Value acceptor 208 can be combined with a currency reader and validator, and a code reader for reading value encoded on paper tickets. Value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming device 100. During game play, each time a player risks a wager on an outcome, specially configured processor 202 processes the wage and determines the amount of credits to debit from the player's credit balance. When a winning outcome is obtained, specially configured processor 202 is configured to determine the amount of credits to add to the player's credit balance.

As previously mentioned with respect to FIG. 1, a variety of value acceptance arrangements are possible. In one embodiment, the value acceptor 208 could include magnetic strip or chip card readers to accept and transfer value. Value acceptor 208 may also be configured to accept and transfer non-traditional currencies such as digital currencies. In these embodiments, I/O controller 206, a specially configured processor 202, or both contain appropriate control instructions to communicate and extract value from the inserted item containing value. In one embodiment, use of a magnetic strip or embedded chip card, for example a bank card, for value insertion requires specially configured processor 202 to communicate, via network interface controller 224 (described below), with devices external to the gaming device 100.

In one embodiment, card reader 210 may be included in gaming device 100 to accept player loyalty cards. For example, card reader 210 can extract account identifying information from the card and utilizes this information to access the associated account information stored remotely via network interface controller 224. In embodiments where player loyalty/player tracking systems are employed, a player's loyalty account and record of gaming activity can be stored in a networked storage location or database. Specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various embodiments, player control 212 receives a player's game inputs and communicates the player's game inputs to specially configured processor 202. The player's game inputs may include, but are not limited to, wager amounts, pay line selections, game control signals, and cash-out signals. The player control 212 may generate signals based on button presses, touch screen activations, or voice control. The player initiated signals are propagated to the specially configured processor 202 by I/O controller 206. Further, the player initiated signals may direct and inform execution of the game instructions stored in memory device 204 and configured to be executed by specially configured processor 202.

In one embodiment, specially configured processor 202 is configured to execute stored program code and instructions which generate random numbers or pseudo-random numbers. In one embodiment, as illustrated in FIG. 2, a random number generator (RNG) 214 is a software module configured to be executed by specially configured processor 202 for the generation of a true random or pseudo-random number. The code for RNG 214 may be stored in memory device 204. RNG 214 generates random numbers for use by the gaming software during game execution. In one embodiment, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various embodiments, once random symbols are selected based upon the random number generated by RNG 214, patterns of symbols are compared to determine wagering outcomes. In an alternative embodiment, gaming device 100 may include a hardware based random number generator that is in communication with specially configured processor 202 to supply random numbers for game generation purposes. The hardware based random number generator may be incorporated into specially configured processor 202 or can be separate from specially configured processor 202. In some embodiments, the random number generator may be located in a central server or a server that is remote from the gaming device 100. The gaming device 100 may receive the randomly generated values from the central server or remote server.

In yet another embodiment, random generation of “numbers” or symbols may be performed with electro-mechanical components. For example, gaming devices such as gaming device 100 may incorporate a plurality of mechanical reels rotatable about a common axis. A plurality of indicia or symbols may be positioned around the periphery of the plurality of reels. Each of the indicia or symbols on each reel may indicate separate detectable reel stop positions. The reels can be set into a spinning/rotation motion by pulling a lever or pushing a button. In some embodiments, the gaming device 100 can stop the reels by the gaming device 100 actuating, on a random timing basis, a suitable mechanical or electro-mechanical reel brake. When the reels stop rotating, one or more displayed stop positions of each reel is detected. Since the stop positions are each associated with an indicia or symbol, the gaming device can determine whether the combination of stop positions (i.e., translating to a combination of displayed symbols) results in a winning symbol combination.

Returning to FIG. 2, control unit 200 controls the function and output of a plurality of output devices utilized by gaming device 100. In various embodiments, I/O controller 206 serves as an interface unit between specially configured processor 202 and output devices such as video processor 216, cabinet lighting controller 218, audio controller 220, and value dispenser 222.

In one embodiment, video processor 216 communicates with specially configured processor 202 to render all game graphics, video displays, and information on gaming device 100's one or more video display units. In one embodiment, video processor 216 includes one or more processors, controllers, and/or graphics cards for processing the game images, outcomes, and animated displays and coordinating the processed data to be display between, among, or across any or all display devices. In various embodiments, this may include being configured to simulate objects and the movement of objects which represent video reels containing sets of gaming symbols.

It should be appreciated that in certain other embodiments where physical mechanical reels are utilized by the gaming device 100 as a game displays, reel controllers and stepper motors would be provided in lieu of or in addition to video processor 216.

In embodiments which utilize cabinet lighting as described with respect to FIG. 1, a cabinet lighting controller 218 may be utilized to coordinate and control the color and timing of cabinet lighting displays with specially configured processor 202. In certain embodiments which utilize sound design, specially configured processor 202 may utilize audio controller 220 to coordinate and control the sound emissions. In one embodiment, audio controller 220 may include one or more audio processing cards for generating sound and for driving the one, two or more speakers that may be included with gaming device 100.

In various embodiments, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In one embodiment, value dispenser 222 can be controlled to issue the player's credit value using any of the types of value discussed herein. In some embodiments, the player's credit value may be issued to the player via a printed and dispensed encoded paper ticket or token which the player can then exchange at a special purpose kiosk or cashier location for the monetary value encoded into the ticket or token. In some embodiments, the specially configured processor 202 can direct the value dispenser 222 to issue to the player an appropriate amount of coin or bills directly to the player. Additionally, or alternatively, in some embodiments, the player may have the option to electronically direct the credit value to an account associated with the player.

In some embodiments, control unit 200 of gaming device 100 may communicate with one or more devices outside the gaming device 100. For example, gaming device 100 may be connected to a larger gaming network via a local area network (LAN) or a wide area network (WAN). Control unit 200 may communicate with one or more central servers, controllers, or remote devices to execute games, establish credit balances, participate in jackpots, etc. In such embodiments, network communications and connections are accomplished via a network interface controller 224. Network interface controller 224 can be a digital circuit board or card installed in control unit 200 to provide network communications with external devices.

In some embodiments, various additional features and functions are performed by control unit 200. For example, control unit 200 may be specially configured with appropriate software to track all game play events that occur on gaming device 100. In some embodiments, control unit 200 may audit all recorded monetary transactions, including all wager amounts, game outcomes, game winnings, and game payouts that occur through gaming device 100. Further, some embodiments may include security software to assist in protecting the gaming device 100 from tamper or alteration attempts.

### Game System Operation

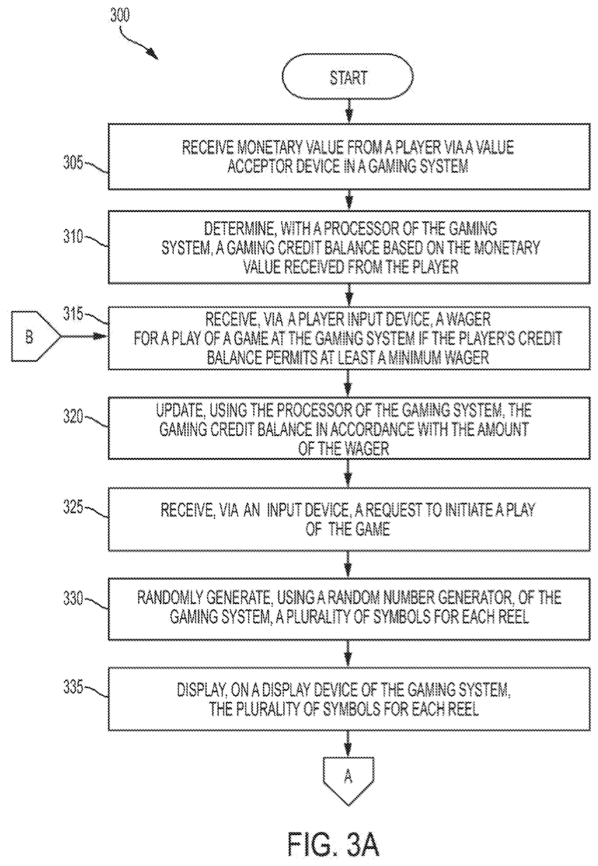

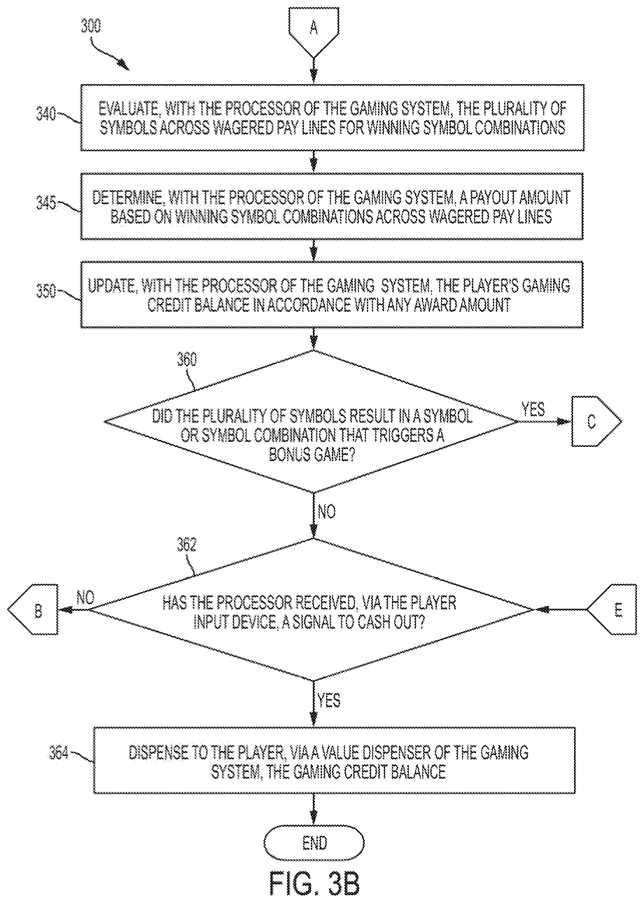

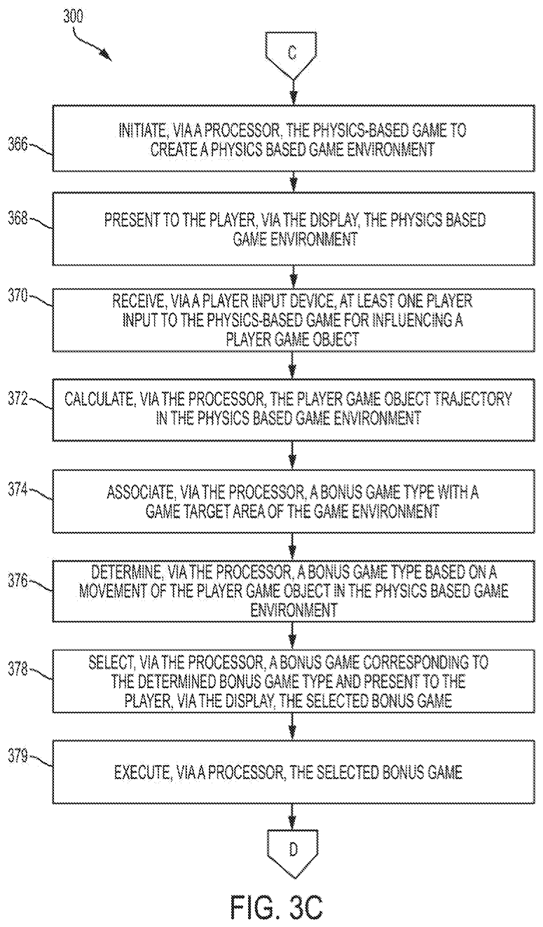

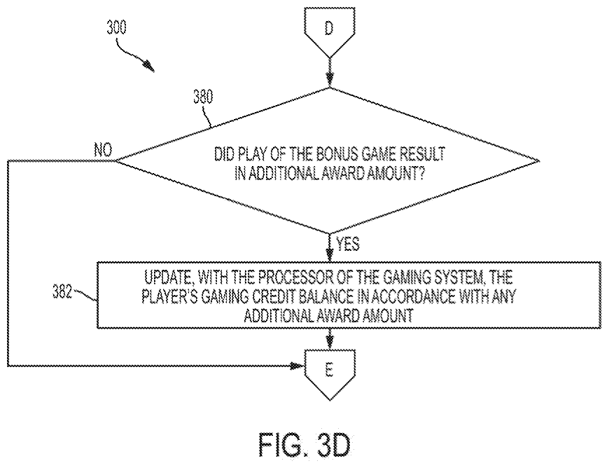

FIGS. 3A, 3B, 3C and 3D illustrate a flowchart of an example operation 300 of one embodiment of the gaming system and method. FIGS. 3A and 3B are depicted as a base or primary game while FIGS. 3C and 3D depict a physics-based game for determining a bonus game. However, it should be appreciated that FIGS. 3C and 3D may be integrated as part of a base game without entering a separate bonus game or a separate physics-based game for determining a bonus game.

In one embodiment, a processor of the gaming system is configured, via instructions stored in a memory device, to perform the operation 300. However, it should be appreciated that other suitable variations of operation 300 are possible. For example, in one embodiment, fewer or one or more additional blocks (not shown) may be employed in operation 300 of the gaming system and method. In other embodiments, the blocks may be performed in any suitable order.

FIG. 3A illustrates one embodiment in which the gaming system receives a monetary value from a player to initiate operation 300. As indicated in block 305, the gaming system may receive monetary value via a value acceptor device associated with the gaming system. The value acceptor device, in one embodiment, is disposed in a gaming system or in communication with the gaming system as discussed above.

In one embodiment, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In one embodiment, the gaming system may receive a wager for a play of a game at the gaming system. Block 315 of FIG. 3A illustrates one embodiment where the player's wager is received via a player input device. The gaming system may allow a player to place a minimum wager, a maximum wager, or any suitable wager amount. Depending on the wager amount, the gaming system may also enable the player to select pay lines across displayed symbol positions on reels in a game in which to place wagers. Although in some embodiments, the gaming system selects the wagered pay lines automatically based on the player's wager. Wagered pay lines may be referred to herein as active pay lines. In one embodiment, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In one embodiment, the gaming system may use a processor of the gaming system to update a gaming credit balance. The credit balance may be updated in accordance with the player's wager amount as indicated in block 320. Some embodiments, the credit balance is not updated until a later time.

Block 325 illustrates one embodiment in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one embodiment, the gaming system may use a random number generator to randomly generate a plurality of symbols from a set of symbols as indicated in block 330. In one embodiment, at least some of the symbols in the set of symbols are classified or associated with a symbol type. In some embodiments, the gaming system may generate the plurality of symbols for display on a set of reels (or virtual reels). As used herein, the random number generation may refer to pseudo-random or true-random number generation depending on the module used for the random number generation.

In one embodiment, the gaming system may cause a display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in one embodiment as shown in block 340, the gaming system evaluates the generated plurality of symbols across active or wagered pay lines for winning symbol combinations. In some embodiments, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one embodiment using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one embodiment, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3D can be rearranged in any suitable order. As such, it should be appreciated that the gaming system may update player's gaming credit balance at other suitable times.

In one embodiment, as indicated in block 360, the gaming system evaluates the plurality of symbols across wagered pay lines for one or more symbols or a symbol combination that may trigger a bonus game. In some embodiments, a plurality of bonus games may be available to the player. In some embodiments, the one or more symbols or a symbol combination that triggers the bonus game do not need to appear on wagered pay lines. In some embodiments, the one or more symbols or a symbol combination that may trigger a bonus game may be a predetermined symbol or symbols, or a predetermined combination of symbols. It should be appreciated that in some embodiments, events other than generating one or more symbols or a symbol combination may trigger the bonus game.

In one embodiment, as indicated in block 360, if the gaming system determined that the generated plurality of symbols did not result in triggering a bonus game, operation 300 moves to block 362. In one embodiment, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

Returning now to block 360, if the gaming system determines that the generated one or more symbols or a symbol combination resulted in triggering a bonus game, operation 300 flows via off page connector C to block 366 of FIG. 3C. In one embodiment, if the gaming system determines that the generated plurality of symbols includes one or more symbols or a symbol combination, the gaming system will trigger or activate a physics-based game to determine a bonus game. In one embodiments, the symbol or symbol combination may be a symbol or symbol combination that serves one function: to trigger the bonus game. In alternative embodiments, the symbol or symbol combination may serve a plurality of game functions, such as triggering the bonus game and providing an award value. Other suitable game functions may be associated with the symbol or symbol combination.

In one embodiment, the gaming system initiates a physics-based game that allows a player to influence the selection of the bonus game without a random number generator. In alternative embodiments, the gaming system may initiate a physics-based game that enables a player to influence the selection of the bonus game in conjunction with a random number generator. The physics-based game may be awarded when a player achieves a triggering symbol or a triggering symbol combination in a base game, as indicated in block 360. In some embodiments, play of the physics-based game determines the bonus game awarded to the player.

As shown in block 366, the gaming system initiates, via a processor, play of a physics-based game by creating the physics-based game environment. The gaming system processor presents, via the display, the physics-based game for determining a bonus game to the player in block 368. In one embodiment, a physics-based game environment, or playfield, may be created and displayed to the player. The physics-based game simulates the movement of a player game object interacting with a physics-based game environment in accordance with a physics simulation module or physics engine.

In some embodiment, the physics-based game environment includes a player object that exhibits movement within the physics-based game environment. In one embodiment, the player game object may be a spinning wheel or a spinning top. In some embodiments, the physics-based game environment includes a player game object that traverses the physics-based game environment. In one embodiment, the player game object may be a projectile. In one embodiment, the player game object may be an aerial projectile. In one embodiment, the player game object may be a projectile such as a ball. In one embodiment, the player game object may be a vehicle. It should be appreciated that any suitable player game object may be created as appropriate for any suitable physics-based game environment and in accordance with any suitable physics-based game implementation.

In some embodiments, the physics-based game environment may include one or more game elements. In one embodiment, a game element may alter a trajectory of the player game object as the player game object traverses the physics-based game environment using simulated physics modeling. In some embodiments, a game element may randomly alter a trajectory of the player game object as the player game object traverses the physics-based game environment. In one embodiment, the player game object may interact with one or more other game elements as the player game object traverses the physics-based game environment. In some embodiments, the game element may interact with player game objects in a manner that alters the trajectory of the player game object in the physics-based game environment. In one embodiment, the game element may cause a player game object reaction to the game element. The player game object may bounce or otherwise alter the trajectory of the player game object. In one embodiment, the game element may randomly alter the trajectory of the player game object. It should be appreciated that any suitable game element may be created as appropriate for any suitable physics-based game environment and in accordance with any suitable physics-based game implementation.

In some embodiments, the physics-based game environment may also include at least one game target area. The game target area may be a region of the physics-based game environment designated as a goal or game ending task completion. In some embodiments, the game target area may be visibly designated in the physics-based game environment. In some embodiments, the gaming system may enable a player to provide inputs in the physics-based game to at least partially manipulate the player game object towards a game target area. In some embodiments, a bonus game may be associated with a game target area. In one embodiment, a plurality of game target areas may be included in the physics-based game environment, and each target area may have a bonus game associated therewith. In this manner, the player's manipulation of a player game object into a target area of the physics-based game environment may result in a particular bonus game associated with the target area being awarded to the player. It should be appreciated that any suitable game target areas may be created as appropriate for any suitable physics-based game environment and in accordance with any suitable physics-based game implementation.

As indicated in block 370, the gaming system receives, via a player input device, at least one player input to the physics-based game. The player may influence movement of the player game object during a play of the game based on the player's input through the player input device at the gaming system. In this manner, the player may have an influence over the movement of the player game object. In some embodiments, the player may manipulate the player input device of the gaming system to influence or control at least an initial movement of the player game object. In some embodiments, the player may manipulate the player input device to influence or control the entire movement of the player game object. In one embodiment, the player input device may be one of the buttons contained in player control button area 114 through which players may interact with the one or more processors of gaming device 100 and direct game play as discussed in relation to FIG. 1. In one embodiment, the player input device may be included in the physics-based game environment and simulated on a touch screen display of the gaming device. In this manner, the player input device may be simulated in a manner that thematically aligns with the physics-based game. In one embodiment, the player may be invited to initiate play of the physics-based game by imparting an initial movement to the player game object via an activation of a player input device. The physics-based game environment may be displayed on first display 122 of gaming device 100 illustrated in FIG. 1, and display device 122 may include a touch sensitive display. However, any other suitable game display may be used.

A play of the physics-based game may include the player game object traversing the physics-based game environment from an initial position to a game target area. In one embodiment, the player may manipulate the player input device to impart an initial trajectory to the player game object. In one embodiment, the player may manipulate the player input device to control the player game object while the player game object traverses through the physics-based game environment. In another embodiment, the player may manipulate the player input device to select player game object features, materials, or parameters such as, but not limited to, player game object hardness, player game object size, player game object weight, and the like. It should be appreciated that any suitable level of player influence over the player game object as the player game object interacts with the physics-based game environment may be created or allowed, as appropriate, for any suitable physics-based game implementation.

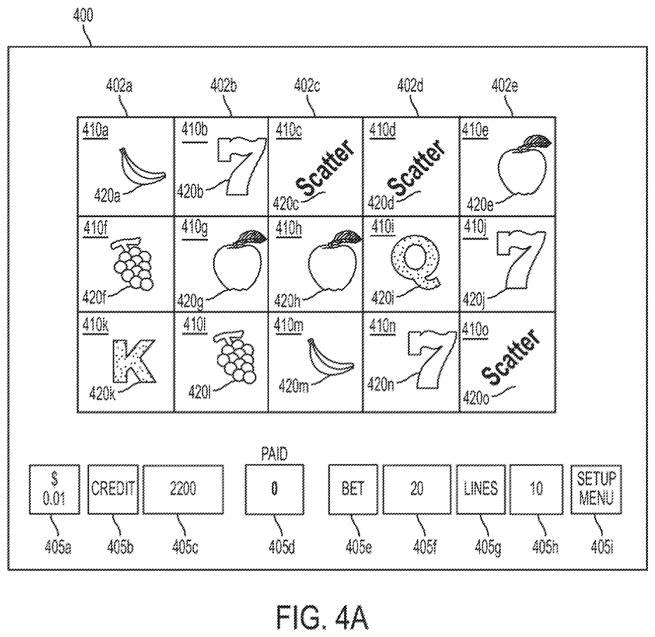

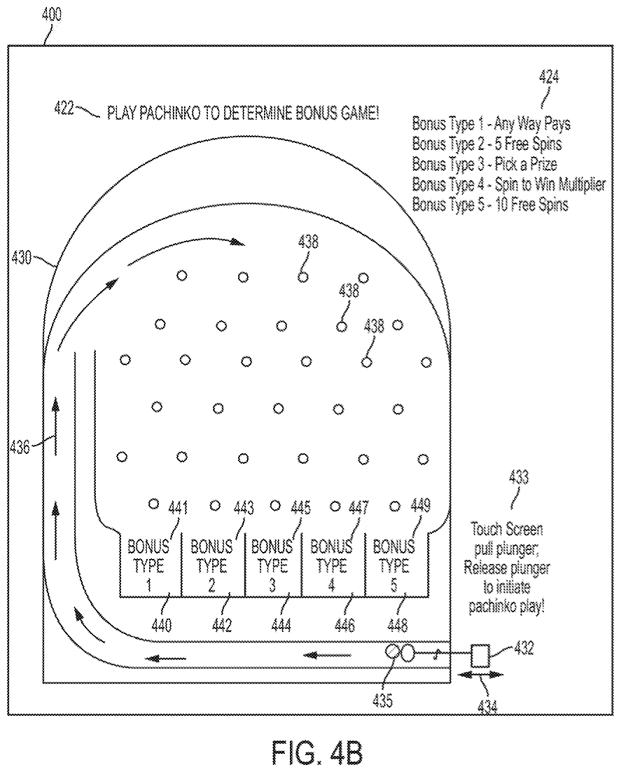

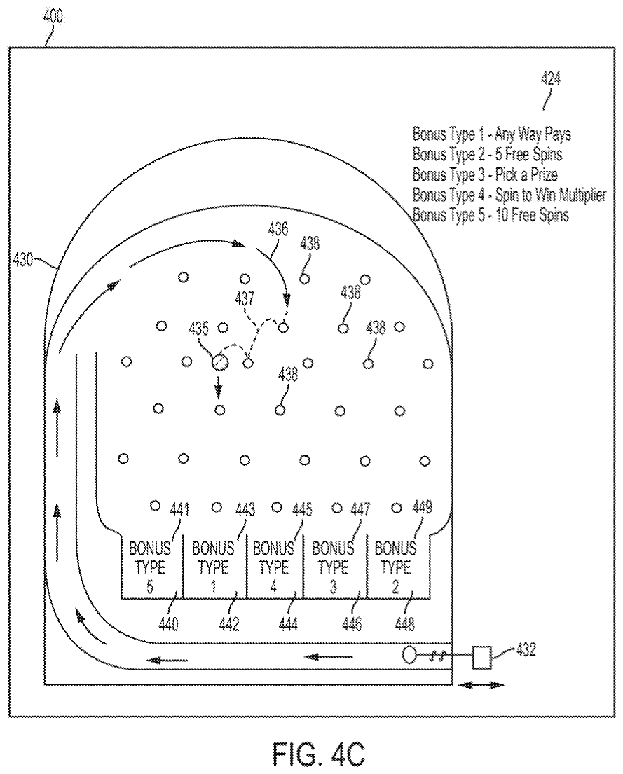

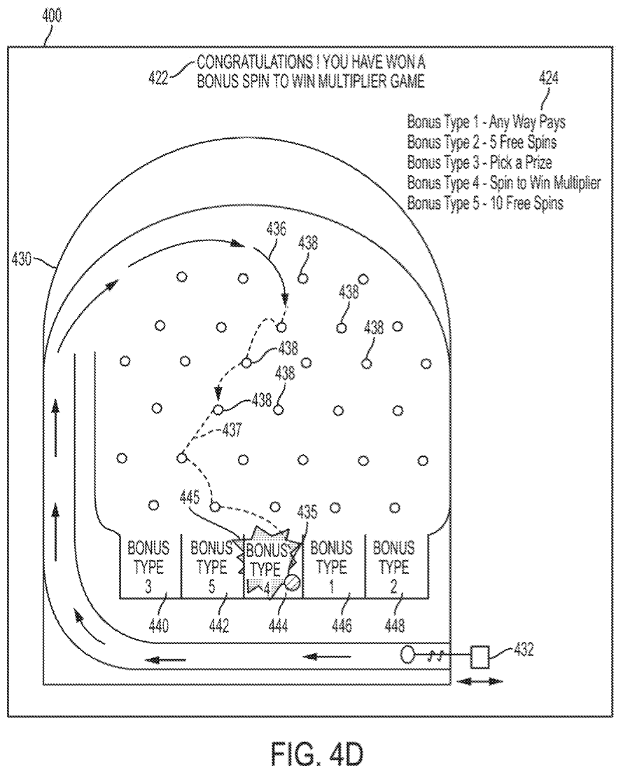

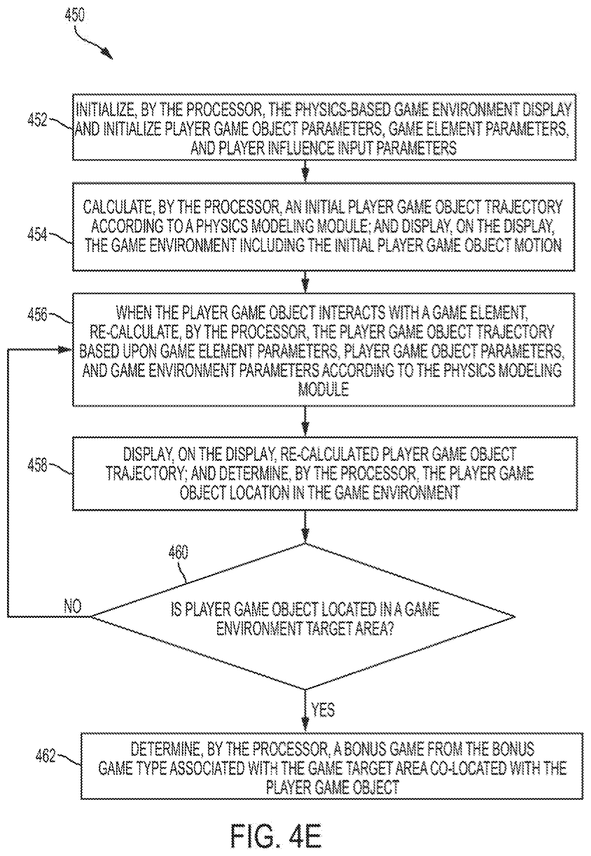

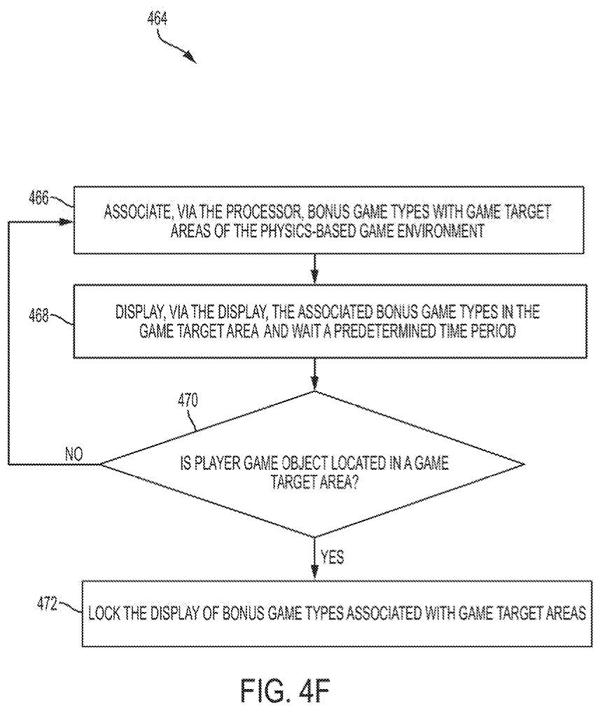

In block 372, the gaming system calculates, via the processor, the player game object movement in the physics-based game environment. Beginning with an initial movement, the gaming system evaluates the player game object interactions with game elements and an influence of any player input to calculate, according to the constraints of a physics simulation module or physics engine, the trajectory of the player game object through the physics-based game environment. It should be appreciated that any suitable physics simulation module or physics engine appropriate for a respective physics-based game environment may be utilized by the physics-based game in accordance with any suitable physics-based game implementation. One embodiment of a player game object trajectory calculation is discussed below in FIG. 4E.

Moving to block 374, the processor of the gaming system additionally associates a bonus game type with each game target area of the physics-based game environment. In some embodiments, the gaming system may associate one of a plurality of bonus game types with one of a plurality of game target areas of the physics-based game environment. In some embodiments, each of the plurality of game target areas is associated with a different one of the plurality of bonus game types. In some embodiments, some of the plurality of game target areas are associated with a same one of the plurality of bonus game types. The gaming system may use predetermined associations of a bonus game type with a game target area in some embodiments. In other embodiments, the gaming system may randomly determine associations between a bonus game type and a game target area. In one embodiment, the gaming system may randomly determine an association of a bonus game type with a game target area and the gaming system may periodically randomly reassign the associations during a play of the physics-based game. One embodiment of associating bonus game types with game target areas is discussed below in FIG. 4F.

As indicated in block 376, the processor may determine a bonus game type based on a movement of the player game object in the physics-based game environment. During a play of the physics-based game, the gaming system using the processor may cause the player game object to traverse a physics-based game environment trajectory, which results in the player game object intersecting (e.g., reaching, hitting, striking, co-locating with, etc.) a game target area. It should be appreciated that as used in this disclosure, terms (e.g., intersecting reaching, hitting, striking, co-locating with, etc.) may be used interchangeably to describe an interaction with a player game object and a game target area. However, in some specific embodiments, such terms may take on a different meaning in the context of a specific physics-based game. For example, in a simulated pachinko game, when a pachinko ball enters a particular one of the game target areas at the bottom of the pachinko game, the pachinko ball may be “co-located” with the particular game target area. In another example, in a simulated baseball game, when a baseball hits a section of outfield back wall (possibly a game target area), the baseball hits or strikes the game target area.

In one embodiment, the gaming system processor determines the bonus game type associated with a game target area. In one embodiment, the gaming system processor determines the bonus game type associated with a game target area when the gaming system processor determines a player game object is co-located in a game target area.

After the gaming system determines a bonus game type in block 376, the gaming system may select a bonus game corresponding to the determined bonus game type, as illustrated in block 378. In one embodiment, one bonus game may be associated with each bonus game type utilized during play of the physics-based game. In one embodiment, a plurality of bonus games may be associated with each bonus game type utilized during play of the physics-based game. In such an embodiment, the gaming system may further select or randomly determine a bonus game associated with the determined bonus game type. In this manner, the gaming system may offer a large variety of bonus games to a player for playing the physics-based game. It should be appreciated that the use of bonus game types allows for a great number and variety of bonus games to be available, via play of the physics-based game, to the player of the base game. The potential for a great variety of bonus games increases player excitement and satisfaction with the game and reduces player fatigue and boredom. Further, by providing a physics-based game for determination of the awarded bonus game, the player has at least some influence over the bonus game determination and is engaged with the gaming machine in an interactive manner. It should also be appreciated that in some embodiments, bonus games may be associated with game target areas without the use of bonus game types.

Continuing in block 378 of FIG. 3C, the gaming system processor presents to the player, via a gaming system display, the selected bonus game. In one embodiment, play of the selected bonus game proceeds according to the type of bonus game selected. In one embodiment, the bonus game may include an additional reel spin game having a special feature not provided in the base game. In one embodiment, the bonus game may include an additional reel spin game having a special feature such as an any ways pay feature. In one embodiment, the bonus game may include a predetermined number of additional reel spin games provided to the player without an associated wager amount (i.e., free spin games). In one embodiment, the bonus game may allow a player to obtain an award directly from play of the bonus game. In one embodiment, the bonus game may allow the player to select up to a predetermined number of displayed objects to reveal an award feature or an award amount. In some embodiments, the award amount may immediately increase the players credit balance. In one embodiment, the award feature may be a bonus multiplier value that may be applied to a future award amount. As can be appreciated, any suitable type of bonus game, bonus value, or bonus feature may be associated with bonus game types and made available to the player via play of the physics-based game. In block 379, the gaming system processor executes the selected bonus game and operation 300 moves, via off page connector D, to block 380 of FIG. 3D.

At block 380 of FIG. 3D the gaming system determines if play of the bonus game resulted in any additional award amounts for the player. When the gaming system determines that no additional award amounts are generated for the player during play of the bonus game, operation flow 300 returns to step 362 of FIG. 3B via off page connector E in the same manner as described hereinabove with respect to a “no” outcome in block 360. When the gaming system, at block 380, determines that an additional award amount is generated for the player during play of the bonus game, operation flow 300 moves to block 382. In block 382, the gaming system, using the processor, updates the player's gaming credit balance in accordance with any award amount for the bonus game and may proceed to off page connector E and returns to block 362 in FIG. 3B. In one embodiment, the gaming system may award certain game features during a play of a base game or during play of a bonus game that cannot be used during the play the base game. The gaming system may store these unused game features and may enable a player to use these stored features during a next play of the base game (not shown in operation flow 300).

As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

FIGS. 4A-4F illustrate one embodiment of a game including a physics-based game for determining a bonus game.

FIG. 4A illustrates one embodiment of a game display 400 that the gaming device 100 may display on a display device of the gaming system. In one embodiment, game display 400 may be displayed on first display 120 of gaming device 100 illustrated in FIG. 1. However, any other suitable display may be used. The game display 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game display 400 is merely representative and may have more or fewer game elements (e.g., reels, symbol display areas, symbols, etc.) shown in the game display 400. It should also be appreciated that other games may be used for the primary or base game.

The plurality of reels 402a-402e are each associated with a set of symbols, where each set of symbols includes a plurality of symbols. Each set of symbols can be associated with the same or a different plurality of symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the set of symbols may include pay symbols and special or designated symbols. In one embodiment, at least one predetermined symbol is a triggering symbol for a bonus game. In one embodiment, at least one triggering symbol must be generated on the reels during a play of a game to trigger the bonus game. In some embodiments, a plurality of triggering symbols must be generated on the reels during a play of a game to trigger the bonus game. In one embodiment, any one of the symbols in the sets of symbols can be designated as the predetermined triggering symbol. The triggering symbol may be associated with one function (e.g., triggering a bonus game), but may alternatively be associated with a plurality of different game functions. The triggering symbol may be a scatter symbol in some embodiments.

Returning now to FIG. 4A, the game display 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. These pluralities of symbol display areas can be associated in a manner that provides the appearance of game reels. It should also be appreciated that the symbol display areas may not be associated with game reels in some embodiments. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In one embodiment, the plurality of symbol display areas that provide the appearance of five game reels may be arranged in a manner that visibly shows three symbol positions of each of the five game reels. For example, the symbol display areas 410a-410o are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The arrangement illustrated in the embodiment of FIG. 4A thus creates a visible display area of the reels 402a-402e comprising three visible symbol positions for each reel. When viewed together, reels 402a-402e appear like a 3-row by 5-column reel array in display 400. In other embodiments, smaller or larger visible areas of the reels can be displayed. That is, the reels 402a-402e may show fewer or a larger number of visible symbol display areas. While symbol display areas are illustrated with defined boxes, it should be appreciated that in some embodiments, the defined boxes are not visible to the player. It should also be appreciated that in some embodiments, the symbol display areas are other shapes or not defined shapes and may not be associated with reels.

Each reel 402a-402e may display a plurality of symbols that the gaming system generates from the sets of symbols in their respective symbol display areas as illustrated in FIG. 4A. In one embodiment, the reels may be shown spinning in one direction to simulate slot machine reels. However, it should be appreciated that the reels may be shown spinning in any suitable direction. The reels may also be shown spinning in different directions in some embodiments.

Game display 400 also includes several information areas and buttons 405a-405i. These information areas and buttons 405a-405i are illustrated in a particular arrangement but may be arranged in any suitable manner in different embodiments. In some embodiments, game display 400 may include more or fewer display areas and buttons 405a-405i than illustrated. Information area 405a illustrates an example value of one credit for the game displayed in game display 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming device 100. Information area 405f illustrates that the player has selected to wager 20 credits per select line. Button 405g illustrates a software button that the player can select to determine how many pay lines to wager on. It should be appreciated that the functionality of button 405g may also be replicated or replaced with a hardware button on the gaming device 100. Information area 405h illustrates that the player selected to wager on 10 pay lines. Thus, in the illustrated embodiment, the player has wagered 20 credits for each of 10 lines resulting in a wager of 200 credits for a play of the game. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In one embodiment, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In one embodiment, the gaming system may also update the player's credit meter (information area 405c) to reflect the player's available credit balance. As shown in FIG. 4A, the player's credit meter (information area 405c) was decremented by 200 credits from 2400 to 2200 to reflect the 200 credit wager the player placed for the play of the game, as explained above.

The gaming system displays the generated symbols 420a-420o in symbol display areas 410a-410o as illustrated in FIG. 4A. Symbols 420a-420o displayed on reels 402a-402e illustrate the randomly generated symbols from the set of symbols after the reels have stopped spinning. As illustrated in FIG. 4A, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e.

As illustrated in FIG. 4A, the gaming system generated and displayed Banana symbols (420a, 420m), Seven symbols (420b, 420j, 420n), Scatter symbols (420c, 420d, 420o), Apple symbols (420e, 420g, 420h), Grape symbols (420f, 420l), a Queen symbol (420i), and a King symbol (420k) in the game display 400. It should be appreciated that the displayed symbol combinations are merely for explanatory purposes and the gaming system may randomly generate any suitable combination of symbols based on defined symbol sets associated with the reels 402a-402e.

FIG. 4A further illustrates one embodiment of a gaming system executing an evaluation of the generated symbols on reels 402a-402e for winning symbol combinations. As noted above, the player may have wagered on one or more pay lines (such as 10 pay lines shown in information area 405h). In one embodiment, at least the active (wagered on pay lines) are evaluated for winning symbol combinations. Any suitable number of pay lines may be used to evaluate winning symbol combinations.

In the embodiment illustrated in FIG. 4A, the gaming system evaluated the generated symbol combinations for winning symbol combinations. In FIG. 4A, the gaming system determined that no winning symbol combination is displayed across any wagered pay line. The gaming system evaluated the randomly generated symbols 410a-410o in symbol positions 420a-420o with a corresponding pay table (not shown) for the play of the base game. The gaming system determined that no combination of symbols exist along a wagered pay line that corresponds with a predetermined combination of symbols found in a corresponding pay table. However, it should be appreciated that in other plays of the game, the gaming system may generate winning symbol combinations. In such an embodiment, the gaming system may determine the corresponding award value indicated by a pay table corresponding to the generated winning symbol combinations and the gaming system may award the value to the player as noted in the discussion of blocks 345 and 350 of FIG. 3B.

As noted at block 360 of FIG. 3B, in one embodiment, the gaming system may also evaluate the generated symbols on reels 402a-402e for triggering symbols that trigger a bonus game. In one embodiment, the gaming system may trigger a bonus game when the gaming system generates at least three Scatter symbols in any three positions on the reels 402a-402e, as illustrated in FIG. 4A. (i.e., the game pay table (not shown) may indicate that three Scatter symbols triggers a bonus game selection via a play of a physics-based game). In some embodiments, the gaming system may provide plays of the physics-based game for determining the bonus game in exchange for some value from the player. For example, the player may be required to wager at a certain predetermined level or play the game over a certain period of time. In some embodiments, the gaming system may require the player to wager a predetermined amount to obtain the physics-based game for determining the bonus game.

Returning to FIG. 4A, the gaming system determined that three Scatter symbols (420c, 420d, and 420o) were generated for the play of the game. In the illustrated embodiment, the Scatter symbol was designated as the bonus game triggering symbol and three Scatter symbols was designated as the predetermined number of bonus game triggering symbols. It should be appreciated that any other suitable symbol could be designed as the bonus game triggering symbol. In some embodiments, more than one different symbol can be designated as a bonus triggering symbol. In some embodiments, a combination of different triggering symbols along a pay line may be required to trigger a bonus game. In some embodiments, a different predetermined quantity of scatter symbols can be used as a bonus game trigger. In some embodiments, the scatter symbols may need to appear on a wagered pay line to trigger the bonus game. In some embodiments, the gaming system may highlight the Scatter symbols in some manner (not shown) so that player understands that the player won a bonus game or other game features. It should be appreciated that the gaming system may highlight the bonus triggering symbol in any suitable manner. It should also be appreciated that the gaming system may not highlight the bonus triggering symbols in some embodiments, as is illustrated in FIG. 4A.

In some embodiments, the gaming system may be required to generate more than one bonus triggering symbol to activate a bonus game. In other embodiments, the features available in the bonus game may depend on the quantity of bonus triggering symbols that the game system generates. In one embodiment, at least one bonus trigging symbol must be generated in the far most reel 402a (in any symbol display area) to trigger the bonus game. That is, if the at least one bonus triggering symbol is generated in reels 402b, 402c, 402d, or 402e, (but not in reel 402a) the gaming system may not activate the bonus game. However, in other embodiments, the bonus triggering symbol may appear on any reel in any symbol display area to trigger the bonus game. In some embodiments, the gaming system may evaluate the bonus triggering symbols from a left to right direction along the reels. In some embodiments, the gaming system may evaluate the bonus triggering symbols from a right to left direction along the reels.

Returning to FIG. 4A, the gaming system determined that three triggering symbols (the Scatter symbols 420c, 420d, and 420o) were generated on reels 402c, 402d, and 402e in symbol display areas 410c, 410d, and 410o. Based on the generated bonus triggering symbol on such reels, the gaming system activates a physics-based bonus game for determining a bonus game.

Turning now to FIG. 4B, the physics-based game environment for one embodiment of a physics-based game is shown as displayed on game display 400. Game display 400 may be displayed on first display 120 of gaming device 100 illustrated in FIG. 1. However, any other suitable display may be used. In one embodiment, the physics-based game of FIG. 4B may be displayed on an additional gaming machine display such as game display 130 illustrated in FIG. 1.

In the embodiment of FIG. 4B, game display 400 no longer displays the reel game as discussed hereinabove with respect to FIG. 4A. When a bonus game award is triggered by a play of the primary or base game, the gaming system generates and displays the physics-based game for determining a bonus game on game display 400. In the embodiment of FIGS. 4B-4F, the physics-based game is illustrated as a simulated pachinko-type game where the physics-based game environment is a pachinko playfield 430. It should be appreciated, however, that any suitable physics-based game may be utilized for determining a bonus game.

In one embodiment, game display 400 may include an information display area 422. Although in FIG. 4B the information display area 422 is illustrated near an upper portion of game display 400, information display area 422 may be displayed at other areas of game display 400. In one embodiment, information display area 422 may be superimposed over at least a portion of pachinko playfield 430. Information display area 422 may inform a player of the type of physics-based game for determining a bonus game and may invite the player to play the physics-based game. In one embodiment, any type of information may be conveyed to a player via information display area 422. In some embodiments, more than one information display area 422 may be included on display 400. In some embodiments, information display area 422 may be optional or may be displayed for a limited time at the beginning of physics-based game play.

In one embodiment, game display 400 may include a bonus type table display area 424. Although in FIG. 4B the bonus type table display area 424 is illustrated near an upper portion of game display 400, bonus type table display area 424 may be displayed at other areas of game display 400. In one embodiment, bonus type table display area 424 may be superimposed over at least a portion of pachinko playfield 430. Bonus type table display area 424 may inform a player of the number of bonus game types available for award in the physics-based game, as well as provide a descriptor of the bonus games associated with each bonus game type. In some embodiments, bonus games may be directly associated with target areas of pachinko playfield 430, as described more fully hereinbelow. In these embodiments, bonus type table display area may provide a listing of the bonus games available for award during play of the physics-based game. In some embodiments, bonus type table display area 424 may be optional or may be displayed for a limited time at the beginning of physics-based game play.

Pachinko playfield 430 includes a player game object, or ball, 435. During play of the physics-based game, ball 435 moves along an initial trajectory 436. Ball 435 may be set in motion along initial trajectory 436 when ball 435 is impacted by player input device or, in the pachinko playfield environment, plunger 432. In one embodiment, the player may be prompted to touch the screen to activate the plunger in instruction display area 433. In one embodiment, a graphic instruction display 434 may be provided for indicating a direction of plunger movement to the player.

In one embodiment, the action of plunger 432 is responsive to the player input (e.g., through the use of a touch screen). When the player touches and drags plunger 432 a large amount to the right prior to releasing the screen touch, plunger 432 may impart a high velocity to ball 435 as it traverses initial trajectory 436. In one embodiment, when the player touches and drags plunger 432 a small amount to the right prior to releasing the screen touch, plunger 432 may impart a low velocity to ball 435 as it traverses initial trajectory 436. A touch responsive plunger 432 allows a player to have an influence over the initial velocity of ball 435 as ball 435 enters pachinko playfield 430.

In some embodiments, a time-out feature may be included which, after prompting the player to utilize plunger 432 to set ball 435 in motion along initial trajectory 436, may automatically plunge ball 435 onto pachinko playfield 430 after a predetermined period of time. In such embodiment, the automatic activation of plunger 432 may impart a default velocity to ball 435 as it traverses initial trajectory 436.

In one embodiment, pachinko playfield 430 contains a plurality of player game objects, or pins 438, which interact with and alter the trajectory of ball 435 as ball 435 traverses pachinko playfield 430. In one embodiment, pins 438 are arranged in a grid pattern. In one embodiment, the grid pattern includes a plurality of equally spaced horizontal rows of pins 438, and each row of pins 438 is vertically offset from an adjacent row of pins 438. With the arrangement of this embodiment, as ball 435 moves over pachinko playfield 430 under the simulated influence of at least an initial trajectory and gravity, each pin in the row of pins 438 is assigned a binary physical attribute. The binary physical attributes may cause a binary direction decision to be made when ball 435 contacts one of the pins 438. Stated differently, as ball 435 moves over pachinko playfield 430 vertically from top to bottom, ball 435 may move to the left or to the right as ball 435 encounters each horizontal row of pins 438. In some embodiments, when ball 435 strikes a pin 438, additional physics-based attributes may be associated with a pin. In such an embodiment, the hardness of the pin 438, the angle the ball 435 strikes the pin, and other physics-based attributes can be used to calculate how the ball 435 moves after hitting a pin 438. It should be appreciated that pins 438 may be arranged in any suitable pattern. In some embodiments, additional game elements for altering ball 435 trajectory may additionally or alternatively be included on pachinko playfield 430. In some embodiments, the additional game elements, while having physics-based attributes, may exert a physics-based randomizing action on how the ball 435 moves through the pachinko playfield 430. In one such embodiment, one or more rotating objects (not shown) may alter or redirect ball 435 on pachinko playfield 430. The angle that the ball 435 hits a rotating object may cause the ball 435 to move in a randomized direction based on the physics of the motion of the rotating object and the ball 435.

In one embodiment, pachinko playfield 430 includes a plurality of game target areas 440, 442, 444, 446, and 448. These game target areas span the lower portion of pachinko playfield 430. As ball 435 concludes traversal over pachinko playfield 430, ball 435 will cease motion in one of the plurality of game target areas 440, 442, 444, 446, or 448. In one embodiment, pachinko playfield 430 may include a greater number of game target areas or a small number of game target areas. In one embodiment, pachinko playfield includes at least one game target area.

Continuing in FIG. 4B, each target area 440, 442, 444, 446, and 448 has an associated bonus game type. Each associated bonus game type may be displayed adjacent to or within each game target area. As illustrated in FIG. 4B, bonus game type 1 may be associated with target area 440 and may be visually indicated to the player in display area 441. Bonus game type 2 may be associated with target area 442 and may be visually indicated to the player in display area 443. Bonus game type 3 may be associated with target area 444 and may be visually indicated to the player in display area 445. Bonus game type 4 may be associated with target area 446 and may be visually indicated to the player in display area 447. Bonus game type 5 may be associated with target area 448 and may be visually indicated to the player in display area 449. In some embodiments, the visual indication to the players may be indicia that is associated with a bonus game type via bonus type table 424. In some embodiments the indicia may be a symbol. In one embodiment, the indicia may be a number. In one embodiment the indicia may be a color. In another embodiment, the indicia may be a text description of the bonus game type. In one embodiment, the indicia may be a name of a bonus game.

FIG. 4C illustrates a state of the physics-based game after plunger 432 hit ball 435 and ball 435 has followed initial trajectory 436 and has entered the pachinko playfield 430. In one embodiment, ball 435 has encountered a plurality of pachinko playfield pins 438 as illustrated by the initial trajectory 436 and a calculated trajectory 437. The calculated trajectory may be determined by a gaming system processor in accordance with operation flow 450 described below in relation to FIG. 4E. As mentioned above, as ball 435 encounters each pin 438 on pachinko playfield 430, a binary direction decision (left, right) may be made by the gaming system processor. A new trajectory may be calculated by a physics simulation module of the gaming system processor, and ball 435 movement is displayed as indicated by calculated trajectory 437.

In one embodiment, during the time that ball 435 is traversing pachinko playfield 430 via calculated trajectories 436 and 437, the gaming system may randomly reassign bonus game types to each of game target areas 440, 442, 444, 446, and 448 on a periodic basis. The frequency of the bonus game type reassignments may be based on a predetermined time period or a variable time period. In the embodiment of FIG. 4C, bonus game type 5 may now be associated with game target area 440 and may be visually indicated to the player in display area 441 as opposed to bonus type 1 as illustrated in FIG. 4B. Likewise, bonus game type 1 may now be associated with game target area 442 and may be visually indicated to the player in display area 443. Bonus game type 4 may now be associated with game target area 444 and may be visually indicated to the player in display area 445. Bonus game type 3 may be associated with game target area 446 and may be visually indicated to the player in display area 447. Bonus game type 2 may be associated with game target area 448 and may be visually indicated to the player in display area 449. In some embodiments, the bonus game types may be randomly re-associated with game target areas. In one embodiment, the bonus game types may be shifted from right to left or from left to right. As can be appreciated, the physics simulation module may determine the final target area ball 435 falls to, and an element of chance may determine which bonus game type is associated with the final target area when ball 435 arrives (or is co-located with).

Turning to FIG. 4D, play of the physics-based game has advanced as ball 435 has continued along calculated trajectory 437. Ball 435 has entered game target area 444 as a final position. In one embodiment, the bonus game type associated with each game target area 440, 442, 444, 446, and 448 have been randomly reassigned to different target areas for a final time during the play of the physics-based bonus game. As discussed above, in some embodiments, once a player game object has reached a game target area, the gaming system may stop altering the associations between game target areas and bonus game types. In one embodiment, bonus game type 3 may now be associated with game target area 440 and may be visually indicated to the player in display area 441. Bonus game type 5 may now be associated with game target area 442 and may be visually indicated to the player in display area 443. Bonus game type 4 may now be associated with game target area 444 and may be visually indicated to the player in display area. Bonus game type 1 may now be associated with game target area 446 and may be visually indicated to the player in display area 447. Bonus game type 2 may now be associated with game target area 448 and may be visually indicated to the player in display area 449. Referencing bonus game type table 424, bonus game type 4 corresponds to a Spin to Win Bonus Multiplier game. In one embodiment, information display area 422 may be updated to inform the player of the selected bonus game determined by play of the physics-based game. While the features discussed above are described in relation to a pachinko game, it should be appreciated that such features can be applied to any simulated physics-based game.

FIG. 4E illustrates a flowchart of an example operation 450 of one embodiment of the gaming system and method including a physics-based game for determining a bonus game. In one embodiment, operation 450 may be viewed as a sub-operation of block 372 of operation 300 as illustrated in FIG. 3C. Operation 450 begins with initializing block 452. In one embodiment, the processor of the gaming system initializes and displays the physics-based game environment for display. Initializing the physics-based game environment includes creating and rendering, on the gaming system display, the physics-based game environment. In one embodiment, initialization of the physics-based game environment may include initializing player game object parameters, game element parameters, and player influence input parameters. It should be appreciated that any physics-based game implementation, physics-based game environment and game parameter initialization will be suitably informed by the specific physics-based game implemented for bonus game selection.

In one embodiment of a pachinko type physics-based game as described in FIGS. 4B-4D, the simulated pachinko game may be initialized. Initialization may include creating and rendering the pachinko playfield 430 on a gaming system display. Initializing a pachinko playfield may include, for example, a rendering of the pachinko playfield layout and pin pattern, or a selection of a number of target areas and target area locations. In some embodiments, default pachinko playfield layout designs may be selected and displayed by the gaming system processor.

Block 452 of FIG. 4E indicates that the gaming system processor may initialize player game object parameters. It should be appreciated that specific game parameters and the manner initialized may be selected and determined as suitable for the physics-based game implementation. In one embodiment, pachinko type player game object parameters may include the parameter values necessary to simulate player game object or ball 435 movement and behavior when ball 435 is traversing pachinko playfield 430. In one embodiment, the initialized ball parameters may include parameters such as the ball diameter, the ball weight, the ball material, or the ball surface elasticity. It should be appreciated that player game object parameters may be predefined and have fixed default values for the physics modeling module to utilize.

In one embodiment, the player may select some or all the player game object parameters at the start of the game. In one embodiment, the player may be presented with a variety of player game objects having different characteristic and may be invited to select the player game object for a play of the physics-based game. The pachinko type physics-based game embodiment described hereinabove may, in one embodiment, allow a player to select between player game objects or balls such as a ping-pong ball, a golf ball, a rubber ball, or a glass marble, where each of these selections will possess a different physical characteristic profile for use in the pachinko game simulation. When a player selects an offered ball, the gaming system processor may initialize player game object parameters in a physics modeling module.

Block 452 of FIG. 4E indicates that the gaming system processor may initialize game element parameters. In some embodiments, a game element may randomly alter a trajectory of the player game object as the player game object traverses the physics-based game environment. In one embodiment, pachinko type game element parameters include the parameter values necessary to simulate game element or pin 438 interaction with ball 435 when ball 435 interacts with pin 438 during traversal of pachinko playfield 430. In one embodiment, the initialized pin parameters may include parameters such as the pin height and diameter, the pin material, or the pin hardness. It should be appreciated that player game object parameters may be predefined and have fixed default values for the physics modeling module to utilize. In some embodiments, the gaming system may not use all the available game element parameters during a play of a physics-based bonus game.

Block 452 of FIG. 4E indicates that the gaming system processor may initialize player influence input parameters. It should be appreciated that player influence input parameters are sometimes also referred to herein as “input parameters.” The physics-based game environment may additionally include player influence input elements. The gaming system enables the player to attempt to direct the player game object towards the one or more game target areas of the physics-based game environment via a player influence input element. In one embodiment, player influence input element parameters include the parameter values necessary to simulate a player influence input, or plunger 432. Plunger 432 interacts with ball 435 when plunger 432 directs ball 435 on an initial trajectory onto pachinko playfield 430. Plunger 432 imparts an initial motion and speed to ball 435. In one embodiment, the initialized plunger parameters may include parameters such as the plunger spring tension or the length of the plunger pull handle. In one embodiment, default values may be established to direct plunger 432 behavior when a timer expires due to player inaction. In one embodiment, a timer expiration may trigger an automatic plunge of ball 435 onto pachinko playfield 430. It should be appreciated that player influence input element parameters may be predefined and have fixed default values for the physics modeling module to utilize.

Turning to block 454, operation 450 may cause the gaming system processor to calculate an initial player game object trajectory. In one embodiment, the gaming system processor may utilize a physics modeling module, or a physics engine, to calculate an initial player game object trajectory. In one embodiment, a physics modeling module, or physics engine, may be computer software code that provides an approximate simulation of certain physical systems, such as rigid body dynamics, collision detection, and object motion dynamics. It should be appreciated that any suitable physics modeling module may be utilized. Continuing with block 454, operation 450 may cause the gaming system processor to display, on the display, the physics-based game environment including the player game object traversing the physics-based game environment along the calculated initial player game object trajectory.

Block 456 illustrates operation 450 conditionally re-calculating the player game object trajectory. In one embodiment, when the player game object interacts with a game element, the gaming system processor may re-calculate the player game object trajectory based upon parameters such as the game element parameters, the player game object parameters, the physics-based game environment parameters. In one embodiment, the gaming system processor may re-calculate the player game object trajectory utilizing the physics modeling module. Block 458 illustrates that the gaming system may display the player game object motion along the recalculated trajectory. In one embodiment, the gaming system processor may determine the player game object location in the physics-based game environment. In block 460, the gaming system processor determines, in one embodiment, if the player game object is located in a game target area. When the player game object is not located in a physics-based game environment target area, the gaming system may determine that the game is incomplete and operation 450 returns to block 456 and the gaming system repeats the re-calculation of player game object trajectory when the player game object interacts with a game element. In one embodiment, operation 450 continues displaying player game object trajectory, determining object location, and recalculating object trajectory when the player game object interacts with game elements until the processor determines that the player game object is located in a game target area.

Block 462 illustrates operation 450 when the player game object is located in a game target area. In one embodiment, the gaming system processor may determine the bonus game type associated with the game target area co-located with the player game object. When the gaming system processor determines that a player game object has entered a game target area in a physics-based game environment, the gaming system processor may determine a bonus game type associated with the target area. In one embodiment, the gaming system then randomly determines a bonus game from a plurality of different bonus games associated with the determined bonus game type. It should be appreciated that the gaming system processor may determine, by any suitable means, a bonus game corresponding to the determined bonus game type.

As noted hereinabove, operation 450 may be viewed as a sub-operation of block 372 of operation 300 as illustrated in FIG. 3C. In a like manner, FIG. 4F and operation 464 may be viewed as a sub-operation of block 374 of operation 300 as illustrated in FIG. 3C.

Operation 464 associates, via the processor, a bonus game type with a target area of the physics-based game environment. In one embodiment, as illustrated in block 466, the gaming system initially associates bonus game types with target areas of the physics-based game environment. In some embodiments, each of a plurality of game target areas is associated with a different one of a plurality of bonus game types. In one embodiment, a plurality of bonus game types may be associated with at least one game target area. In some embodiments, the gaming system processor may randomly assign bonus game types with game target areas of the physics-based game environment. In one embodiment, bonus games may be assigned to game target areas in lieu of bonus game types.

In block 468, the gaming system processor may display the associated bonus game types in the game target areas. In one embodiment, the gaming system may wait a predetermined period of time before operation 464 moves to block 470 or returns to block 466. In block 470, the gaming system processor determines if the player game object is located in a game target area. When the player game object is not located in a game target area, the game is incomplete and operation 464 returns to block 456 and repeats the random association of bonus game types with game target areas and updating the display. When the gaming system processor determines, in block 470, that the player game object is located in a physics-based game environment target area, gaming system proceeds to block 472. The gaming system locks the display and association of bonus game types with game target areas for the physics-based game in some embodiments as illustrated in block 472. The operation 464 is complete after block 472. In one embodiment, the bonus game type may now be determined in block 376 of FIG. 3C.

It should be appreciated that, in some embodiments, the operation of FIG. 4E and the operation of FIG. 4F may be performed substantially in parallel by the gaming system processor.

The overall operation of FIGS. 3C, 4E, and 4F will now be described as embodied in the simulated pachinko-type physics-based game of FIGS. 4B-4D. In one embodiment of a pachinko-type physics-based game to determine a bonus game, a pachinko playfield may be initialized and displayed to the player. Bonus game types may be associated and displayed with pachinko playfield target areas. The player may touch a touch sensitive display to activate a plunger. When the player releases the touch sensitive display, the plunger may impact a ball to project the ball upon an initial trajectory onto the pachinko playfield. The pachinko playfield may include many pins which, when struck by the ball, alter the ball trajectory from an initial trajectory to a calculated trajectory. As the ball is traversing the pachinko playfield, the associated bonus game types may be randomly re-associated with game target areas. The ball trajectory is recalculated upon each ball intersection with a playfield pin according to a physics modeling module. When the ball reaches a playfield target area, the display of bonus game types in the game target areas may be locked. The bonus game type associated with the game target area co-located with the ball is determined, and the gaming system may present to the player a bonus game that is associated with the determined bonus game type.

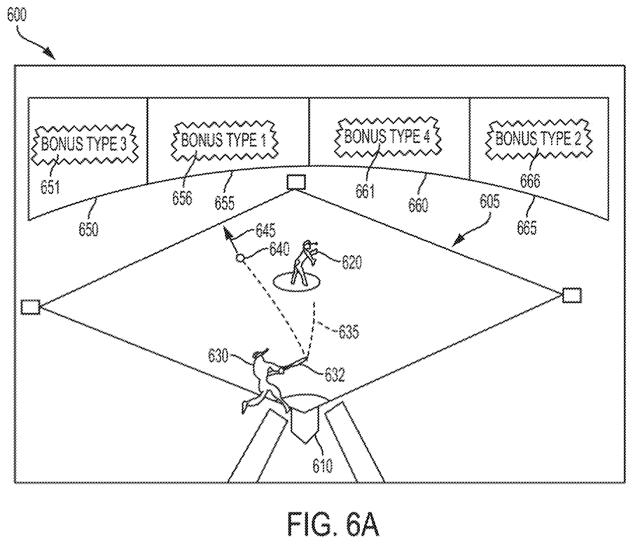

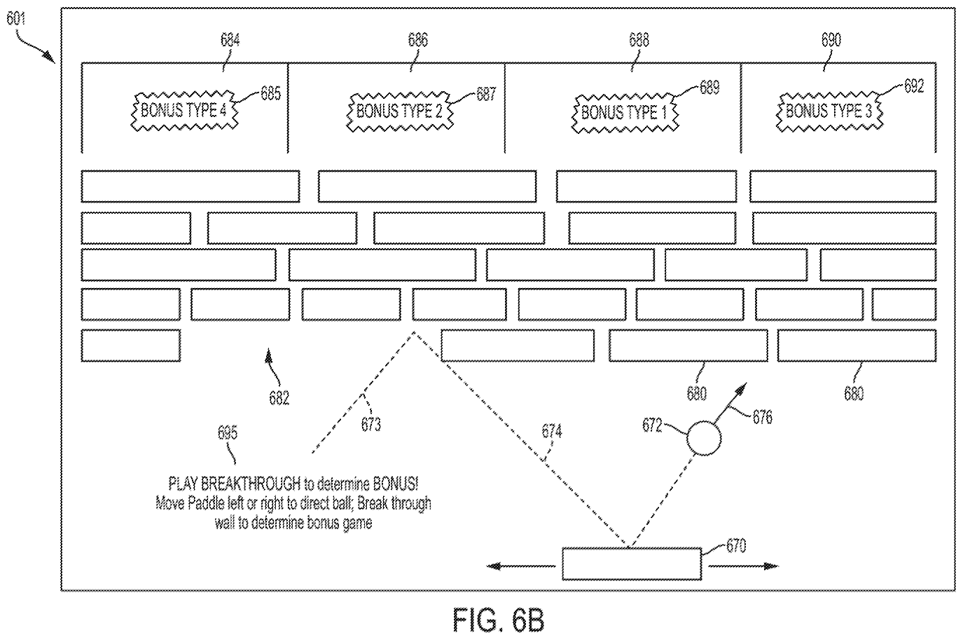

It should be appreciated that the operation described above with respect to FIGS. 3C, 4E and 4F may also describe other physics-based games for determining a bonus game as described hereinbelow with respect to FIGS. 6A and 6B.

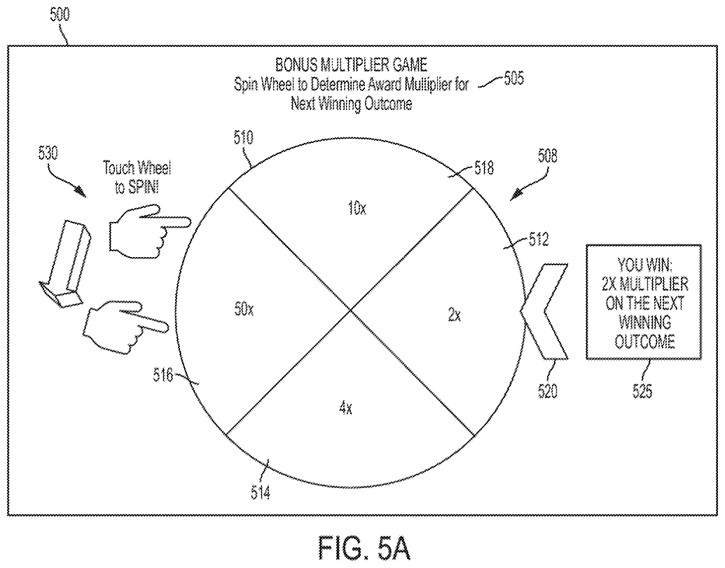

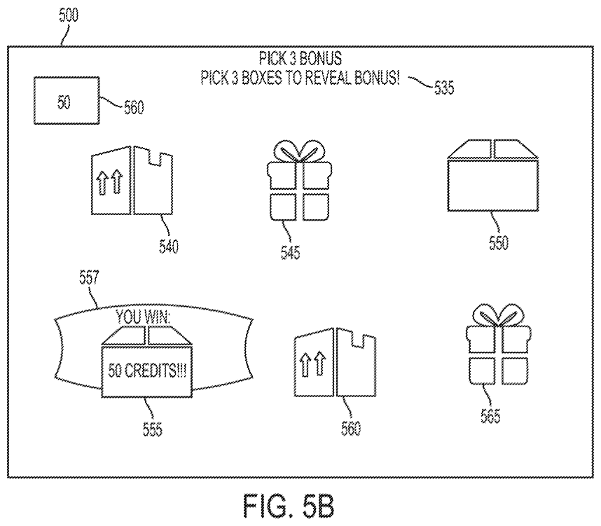

FIG. 5A illustrates one embodiment of a bonus multiplier type game that may be selected as a bonus game by play of a physics-based game. In the embodiment of FIG. 5A, game display 500 no longer displays the reel game as discussed hereinabove with respect to FIG. 4A or the pachinko physics-based game discussed hereinabove with respect to FIGS. 4B-4D. When a bonus game award is triggered by a play of the primary or base game and determined by a physics-based game, the gaming system generates and displays the awarded bonus game on game display 500. Game display 500 may be displayed on first display 120 of gaming device 100 illustrated in FIG. 1. However, any other suitable display may be used. In one embodiment, the bonus game of FIG. 5A may be displayed on an additional gaming machine display such as game display 130 illustrated in FIG. 1.

In one embodiment, game display 500 may include an information display area 505. Although the information display area 505 in FIG. 5A is illustrated near an upper portion of game display 500, information display area 505 may be displayed at other areas of game display 500. In one embodiment, information display area 505 may be superimposed over at least a portion of bonus game display area 508. Information display area 505 may inform a player of the type of bonus game awarded and may invite the player to play the bonus game. In the embodiment of FIG. 5A, information area 505 communicates to a player that a bonus multiplier game has been awarded and the player is invited to spin a wheel to determine an award multiplier to be applied to the player's next winning outcome. In one embodiment, any type of information may be conveyed to a player via information display area 505. In some embodiments, more than one information display area 505 may be included on display 500. In some embodiments, information display area 505 may be optional or may be displayed for a limited time at the beginning of bonus game play.

The bonus multiplier game of the embodiment illustrated in FIG. 5A is displayed on display 500 as prize selection wheel 510. In one embodiment, the prize selection wheel 510 may be divided into a plurality of sections and each section may have a display of an award indicia or value of the multiplier prize potentially available to the player. In one embodiment, an award multiplier prize of 2X is illustrated in display section 512, an award multiplier prize of 4X is illustrated in display section 514, an award multiplier prize of 50X is illustrated in display section 516, and an award multiplier prize of 10X is illustrated in display section 518. In other embodiments, the prize selection wheel may include any number of sections and corresponding prize values. Bonus game display 500 may also include, in one embodiment, an instructive display 530. Instructive display 530 may include text, graphics, or a combination of both text and graphics to instruct the player on play of the game. In one embodiment, information display 530 may instruct the player to touch the wheel and move in a direction to impart a spin to the prize selection wheel. In one embodiment, a time out feature may be included to automatically spin the prize selection wheel 510 should the player not activate the spin within a suitable predetermined time period. Prize pointer 520 will point to a section of prize selection wheel 510 when prize selection wheel 510 comes to rest at the end of a spin. In one embodiment, the value contained in the prize selection wheel section adjacent prize pointer 520 will be the bonus multiplier awarded to the player during the game's next winning outcome. Prize indication display 525 may optionally be included on bonus game display 500.

FIG. 5B illustrates one embodiment of a Pick a Prize type bonus game that may be selected as a bonus game by play of a physics-based game. In the embodiment of FIG. 5B, game display 500 no longer displays the reel game as discussed hereinabove with respect to FIG. 4A or the pachinko physics-based game discussed hereinabove with respect to FIGS. 4B-4D. When a bonus game award is triggered by a play of the primary or base game and determined by a physics-based game, the gaming system generates and displays the awarded bonus game on game display 500. Game display 500 may be displayed on first display 120 of gaming device 100 illustrated in FIG. 1. However, any other suitable display may be used. In one embodiment, the bonus game of FIG. 5A may be displayed on an additional gaming machine display such as game display 130 illustrated in FIG. 1.

In one embodiment, game display 500 may include an information display area 535. Although in FIG. 5B the information display area 535 is illustrated near an upper portion of game display 500, information display area 535 may be displayed at other areas of game display 500. Information display area 535 may inform a player of the type of bonus game awarded and may invite the player to play the bonus game. In the embodiment of FIG. 5B, information area 535 communicates to a player that a Pick 3 game has been awarded and the player is invited to pick 3 boxes to reveal a bonus award amount. In one embodiment, any type of information may be conveyed to a player via information display area 535. In some embodiments, more than one information display area 535 may be included on display 500. In some embodiments, information display area 535 may be optional or may be displayed for a limited time at the beginning of bonus game play.

In one embodiment of a pick 3 bonus game, six prize picks may be displayed. In some embodiments, a greater or lesser number of prize picks may be displayed. In one embodiment, the player may be allowed to select a larger number of prize picks. In one embodiment, a player may be allowed to select prize picks until a prize pick indicates no additional selections are available. It should be appreciated that any suitable number of prize picks and player selections may be offered in a pick bonus-type game.

Returning to FIG. 5B, bonus game display 500 contains prize picks 540, 545, 550, 555, 560, and 565. In the embodiment illustrated, a player has selected prize pick 555, as indicated by highlight 557 and the indicia communicating “YOU WIN: 50 CREDITS!!!” Game display 500 may include bonus total area 560 where a sum of prize pick awards may be displayed to the player.

FIG. 6A illustrates another one embodiment of a simulated physics-based game that may determine a bonus game. In the embodiment of FIG. 6A, game display 600 displays a physics-based game for determining a bonus game embodied as a simulated baseball game. FIG. 6A illustrates a physics-based game environment or baseball playfield including baseball diamond 605. In one embodiment, a player game object, or ball 640 is projected on an initial trajectory 635 by player input device, or pitcher 620. The initial trajectory directs the ball from pitcher 620 towards home plate 610 and batter 630. In some embodiments, a player may be allowed to select the type of pitch made by pitcher 620. In this manner, a player may have an influence over the initial trajectory of ball 640. In some embodiments, a second player input device, or batter 630, may swing a player game object, or bat 632, to impact ball 640 and alter the ball trajectory. Ball 640 may travel along a calculated trajectory 645 towards one of game target areas 650, 655, 660, and 665. In one embodiment, game target areas in the baseball physics-based game embodiment may be located adjacent to home-run boundary walls. Game target area 650 may display an associated bonus game type in area 651. Game target area 655 may display an associated bonus game type in area 656. Game target area 660 may display an associated bonus game type in area 661. Game target area 665 may display an associated bonus game type in area 666. In some embodiments, the associated bonus game types may be randomly associated with the game target areas. In one embodiment, the associated bonus game types may be periodically randomly re-associated with game target areas.

The simulated baseball physics-based game embodiment may include any suitable physics-based modeling module to calculate and display a baseball simulation modeling. The baseball physics-based modeling module may use any number of suitable factors in its calculations, such as, but not limited to: speed, direction, gravity, wind velocity and direction, friction, impact angle, rigid body dynamics, soft body dynamics, spring force, material energy absorption, and the like. It should be appreciated that any suitable physics-based modeling engine may be utilized.

The overall operation of FIGS. 3C, 4E and 4F will now be described embodied in the baseball-type physics-based game of FIG. 6A. In one embodiment of a simulated baseball-type physics-based game to determine a bonus game, a baseball playfield may be initialized and displayed to the player. Bonus game types may be associated and displayed with baseball playfield game target areas. The player may touch a touch sensitive display to activate the pitching of a baseball. The baseball is projected towards a batter on an initial trajectory. When the player releases the touch sensitive display, a batter may swing a bat and may impact the baseball to project the baseball upon an initial trajectory into the baseball playfield. The interaction between the bat and the baseball alters the baseball trajectory from an initial trajectory to a calculated trajectory. As the baseball is traversing the baseball playfield, the associated bonus game types may be randomly re-associated with playfield target areas. The ball trajectory is recalculated upon each ball intersection with a playfield object (e.g., game element) according to a physics modeling module. When the ball reaches a playfield target area, the display of bonus game types in the target areas may be locked. The bonus game type associated with the playfield target area co-located with the ball is determined, and the gaming system may present to the player a bonus game of the associated bonus game type.

FIG. 6B illustrates yet another one embodiment of a physics-based game that may determine a bonus game. In the embodiment of FIG. 6B, game display 601 displays a physics-based game for determining a bonus game embodied as a simulated barrier elimination game. FIG. 6B illustrates a physics-based game environment or barrier elimination game playfield including an information display area 695. In one embodiment, a player game object, or ball 672 may be set in motion or projected on an initial trajectory 673 by the gaming system. The initial trajectory 673 may direct the ball towards a wall of game barriers 680 (e.g., game elements). In some embodiments, a player may be allowed to select the initial ball direction. In this manner, a player may have an influence over the initial trajectory of ball 673. When ball 672 impacts any barrier, the barrier may be eliminated from the playfield as indicated in 682. Impact with a barrier alters the trajectory and speed of ball 672 and the calculated trajectory 674 of ball 672 after impact is away from the wall of barriers 680. A player input device, or paddle 670, may be manipulated by the player in a horizontal direction along the bottom of playfield area 601, to impact ball 672 and alter the ball trajectory. In one embodiment, after an impact between ball 672 and paddle 670, ball 672 may travel along a second calculated trajectory 676 and directed towards one of target barriers 680. After additional barriers 680 are impacted and removed, ball 672 may pass through barrier wall 680 and enter one of game target areas 684, 686, 688, or 690. Game target area 684 may display an associated bonus game type in area 685. Game target area 686 may display an associated bonus game type in area 687. Game target area 688 may display an associated bonus game type in area 689. Game target area 690 may display an associated bonus game type in area 692. In some embodiments, the associated bonus game types may be randomly associated with the game target areas. In one embodiment, the associated bonus game types may be periodically randomly re-associated with game target areas. When ball 672 enters a game target area, the associated bonus game type is selected, and a bonus game of the bonus game type may be presented to the player.

The barrier elimination physics-based game embodiment may include any suitable physics-based modeling module to calculate and display the barrier elimination simulation modeling. The barrier elimination physics-based modeling module may use any number of suitable factors in its calculations, such as, but not limited to: speed, direction, gravity, wind velocity and direction, friction, impact angle, rigid body dynamics, soft body dynamics, spring force, material energy absorption, and the like. It should be appreciated that any suitable physics-based modeling engine may be utilized.

The overall operation of FIGS. 3C, 4E and 4F will now be described as embodied in the barrier elimination-type physics-based game of FIG. 6B. In one embodiment of a barrier elimination-type physics-based game to determine a bonus game, a barrier elimination game playfield may be initialized and displayed to the player. Bonus game types may be associated and displayed with barrier elimination game playfield target areas. The player may touch and release a touch sensitive display to activate the initial trajectory of a ball. The ball is projected towards a game barrier on an initial trajectory. When the ball impacts a game barrier, the game barrier is eliminated, and the initial game ball trajectory is altered to a calculated trajectory. The ball returns towards the player who may control, via a touch sensitive display, a game paddle. The player may manipulate the game paddle to intersect the ball moving on a calculated trajectory, thereby causing a trajectory re-calculation and a redirecting of the ball towards game barriers. As the ball is traversing the barrier elimination playfield interacting with and eliminating game barriers, the associated bonus game types may be randomly re-associated with playfield target areas. The ball trajectory is recalculated upon each ball intersection with a playfield object (i.e., a game barrier or the player controlled paddle) according to a physics modeling module. When the ball passes through the barrier layers and reaches a playfield game target area, the display of bonus game types in the target areas may be locked. The bonus game type associated with the playfield target area co-located or hit with the ball is determined as the player's bonus game type. The gaming system may present to the player a bonus game associated with the player's bonus game type.

Based on the forgoing description, it should be appreciated that a gaming system and method having a physics-based game for determining a bonus game creates new and very exciting ways for a player to influence the selection of a bonus game when a bonus game is awarded during base game play. By enabling a player to influence a player game object displayed in a gaming system during the play of a physics-based game, the gaming system may rely on alternatives to random number generation to determine certain outcomes in a play of a game. Moreover, by enabling a player to influence a player game object during the play of a physics-based game, the player has the potential to earn greater awards a resultant bonus game.

A number of embodiments of the invention have been described. Various modifications may be made without departing from the spirit and scope of the invention. For example, various forms of the flows shown above may be used, with steps re-ordered, added, or removed. Accordingly, other embodiments are within the scope of the following claims.

1. A gaming system comprising:
a cabinet;
a processor;
a display device supported by the cabinet;
an input device supported by the cabinet;
a value acceptor supported by the cabinet;
a value dispenser supported by the cabinet;
a memory device that stores a plurality of instructions which, when executed by the processor, cause the processor to:
establish a credit balance based at least in part on a monetary value received by the value acceptor;
place a wager following receipt of a wager input via an input device, the credit balance being decreased by the wager;
initiate, via the processor, a physics-based game to create a physics-based game environment;
display, on the display device, a physics-based game environment;
receive, via the input device, at least one variable input to the physics-based game for variably influencing a player game object movement, wherein the player game object movement is independent of a fixed location;
calculate, via the processor, a player game object movement in the physics-based game environment based on the received variable input;
associate, via the processor, a bonus game with a game target area of the physics-based game environment;
determine, via the processor, the bonus game based on the player game object movement in the physics-based game environment;
execute, via the processor, the determined bonus game;
display, on the display device, any determined awards, the credit balance being increased by any determined awards; and
issue value from the value dispenser based on the credit balance upon receipt of a cash out signal via the input device.

2. The gaming system of claim 1, wherein the processor is further caused to:
display, on the display device, a plurality of randomly generated symbols from a first set of symbols; and
determine if at least one trigger symbol was generated from the first set of symbols.

3. The gaming system of claim 2, wherein the processor is further caused to initiate the physics-based game if the processor determines at least one trigger symbol was generated from the first set of symbols.

4. The gaming system of claim 2, wherein the processor is further caused to:
evaluate the plurality of randomly generated symbols to determine any awards, the credit balance being increased by any determined awards;
and display, on the display device, any determined awards.

5. The gaming system of claim 1, wherein the processor calculates the player game object movement based on a physics modeling module.

6. The gaming system of claim 5, wherein the physics modeling module calculates an initial player game object movement.

7. (canceled)

8. The gaming system of claim 5, wherein the physics-based game environment comprises at least one game element, the game element comprising an influence on the physic-based game environment, and the physics modeling module calculates the player game object movement including at least one game element influence.

9. The gaming system of claim 1, wherein the processor is further caused to:
display, on the display device, the player game object moving in accordance with the calculated player game object movement.

10. The gaming system of claim 1, wherein the processor is further caused to determine the player game object location in the physics-based game environment.

11. The gaming system of claim 1, wherein a bonus game type is associated with each bonus game; and
the processor is further caused to:
assign a bonus game type to a game target area of the physics-based game environment;
determine the bonus game type based on a movement of the player game object in the physics-based game environment; and
determine the bonus game associated with the determined bonus game type.

12. The gaming system of claim 11, wherein the processor is further caused to randomly select a bonus game associated with the determined bonus game type.

13. The gaming system of claim 11, wherein the processor is further caused to randomly assign, on a periodic basis, a bonus game type with a target area of the physics-based game environment.

14. The gaming system of claim 1, wherein the physics-based game environment is a pachinko playfield.

15. A method of operating a gaming system, the method comprising:
receiving, via a monetary value acceptor, a monetary value;
establishing, via a processor of the gaming system, a credit balance based at least in part on the received monetary value;
accepting, from an input device in a housing of the gaming system, a wager amount;
decreasing, via the processor, the credit balance by the wager amount;
creating, via the processor, a physics-based game environment;
displaying, on a display device, the physics-based game environment;
receiving, via an input device, at least one variable input to the physics-based game for variably influencing a player game object movement, wherein the player game object movement is independent of a fixed location;
calculating, via the processor, the player game object movement in the physics-based game environment;
associating, via the processor, a bonus game with a game target area of the physics-based game environment;
determining, via the processor, the bonus game based on the player game object movement in the physics-based game environment;
executing, via the processor, the determined bonus game;
displaying, on the display device, any determined awards;
increasing, via the processor, the credit balance by any determined awards; and
issuing, via the value dispenser, a value based on the credit balance upon receipt of a cash out signal.

16. The method of claim 15, wherein the physics-based game environment comprises a plurality of game elements, at least some of the plurality of game elements are associated with binary physics attributes, wherein the binary physical attributes cause a recalculation of the player game object movement.

17. The method of claim 16, further comprising:
receiving one or more selections of physical attributes that are associated with the player game object; and
calculating the player game object movement in the physics-based game environment based in part on the received one or more selections of physical attributes.

18. The method of claim 16, further comprising periodically randomly assigning a different bonus game with the game target area of the physics-based game environment until the player game object touches the game target area.

19. The method of claim 15, further comprising
calculating, via the processor, the player game object movement based on a physics modeling module.

20. A non-transitory computer-readable storage medium having machine instructions stored therein, the instructions being executable by a processor to cause the processor to:
establish a credit balance based at least in part on a monetary value received by a value acceptor;
place a wager following receipt of a wager input via an input device, the credit balance being decreased by the wager;
initiate, via a processor, a physics-based game to create a physics-based game environment;
display, on a display device, the physics-based game environment;
receive, via the input device, at least one variable input to the physics-based game for variably influencing a player game object movement, wherein the player game object movement is independent of a fixed location;
calculate, via the processor, a player game object movement in the physics-based game environment;
associate, via the processor, a bonus game with a game target area of the physics-based game environment;
determine, via the processor, the bonus game based on the player game object movement in the physics-based game environment;
execute, via the processor, the determined bonus game;
display, on the display device, any determined awards, the credit balance being increased by any determined awards; and
issue value from a value dispenser based on the credit balance upon receipt of a cash out signal via the input device.
